(19) United States
(12) Patent Application Publication
(10) Pub. No.: US 2021/0297461 A1
(43) Pub. Date: Sep. 23, 2021

(54) ONE-ACTION URL BASED SERVICES AND USER INTERFACES

(71) Applicants: Taranjeet ATHWAL, Richmond (CA); Ehtasham Ghani MALIK, Bothell, WA (US); Parminder SINGH, Surrey (CA); URL. Live Software Inc., Richmond (CA)

(72) Inventors: Taranjeet ATHWAL, Richmond (CA); Ehtasham Ghani MALIK, Bothell, WA (US); Parminder SINGH, Surrey (CA)

(73) Assignee: URL. Live Software Inc., Richmond, BC (CA)

(21) Appl. No.: 17/266,200

(22) PCT Filed: Oct. 1, 2018
(86) PCT No.: PCT/US18/53673

§ 371 Date: Feb. 5, 2021

Related U.S. Application Data
(60) Provisional application No. 62/715,827, filed on Aug. 8, 2018.
(60) Provisional application No. 62/724,047, filed on Aug. 29, 2018.

(51) Int. Cl. H04L 29/06; H04L 12/14; H04M 1/72436; G06Q 20/12; G06Q 10/08; G06Q 20/08; G06Q 10/10; G06Q 50/00

(52) U.S. Cl. CPC H04L 65/1069; H04L 65/4015; H04L 12/1453; H04L 65/1073; H04M 1/72436; G06Q 50/01; G06Q 20/127; G06Q 10/0838; G06Q 20/085; G06Q 10/105; G06Q 10/101; G06Q 20/123

(57) ABSTRACT

One-action URL based communications and other services and management of such services through designated UIs are provided. In some examples, URL based calling may be enabled for different communication modes using existing web browsers, components, and protocols without requiring the end users to employ special hardware or software. Indeed, to initiate a communication session, a requestor may not even have to identify themselves, create a user account, or log in to a service. Subscribers of the service may be provided dashboard UIs to manage their communications, communication/profile configurations, and communicate with other service subscribers. In mobile environments, a mobile application may be used to automatically, without any user intervention, receive a request, activate a browser on the mobile device, and log the subscriber in such that the subscriber can receive the request, and accept the request or reject it and employ and benefit from other features of the service

### CROSS-REFERENCE TO RELATED APPLICATIONS

This application claims the benefit of U.S. Provisional Patent Application Ser. No. 62/715,827 filed on Aug. 8, 2018 and U.S. Provisional Patent Application Ser. No. 62/724,047 filed on Aug. 29, 2018. The disclosures of the above applications are hereby incorporated by reference for all purposes.

### BACKGROUND

Unless otherwise indicated herein, the materials described in this section are not prior art to the claims in this application and are not admitted to be prior art by inclusion in this section.

Online communication services are commonly available. Software developed by a variety of companies allows for one-on-one and group calls to be conducted via a downloadable software application. These services typically require both parties to download an application and then provide personal information necessary to establish accounts before they may communicate with one another. This in turn makes it difficult or impossible for non-account holders to initiate or conduct a call unless or until all parties are registered members of the service. Additionally, cross-application (users employing different applications), cross-platform (users employing different platforms, operating systems, web services, etc.), and cross-device (users employing different types of computing devices) calling is difficult, if possible at all, as all parties must have compatible and interoperable software applications downloaded and correctly installed on compatible and interoperable hardware. Furthermore, once new hardware or software is installed, both have to be continuously maintained with the correct upgrades to support communications services on an on-going basis. Even applications or services that utilize user's phone numbers, email addresses, or similar identification require exchange and recognitions by the call management system of a unique identifier. Thus, conventional technologies impose considerable limitations on easy use of web-based telecommunication services.

### SUMMARY

The present disclosure generally describes techniques for providing one-action uniform resource locator (URL) based communication and other services and management of such services through designated user interfaces (UIs).

Embodiments described herein illustrates methods, devices, and systems to overcome challenges of conventional technologies by providing one-action URL based communications and other services and management of such services through designated UIs using existing web browsers, components, and protocols without requiring the end users to employ special hardware or software. A user may enter a designated URL that identifies a service (action), a target person/entity, and context, and receive the identified service. For example, a user may enter a one-action URL to send a message to another person or entity, make a payment (for identified amount) to the other person/entity, or establish a communication session with the other person/entity through any browser and device. Thus, a requestor may simply need a browser, a browser compatible device, and an Internet connection to communicate. Indeed, to initiate a communication session, the requestor may not even have to identify themselves, create a service specific account or log in to a service according to some embodiments.

The foregoing summary is illustrative only and is not intended to be in any way limiting. In addition to the illustrative aspects, embodiments, and features described above, further aspects, embodiments, and features will become apparent by reference to the drawings and the following detailed description. Thus, the foregoing summary is not exhaustive or limiting but rather example of different embodiments non-obvious and unique to a person skilled in the art.

### BRIEF DESCRIPTION OF THE DRAWINGS

The foregoing and other features of this disclosure will become more fully apparent from the following description and appended claims, taken in conjunction with the accompanying drawings. Understanding that these drawings depict only exemplary embodiments in accordance with the disclosure and are, therefore, not to be considered limiting of its scope, the disclosure will be described with additional specificity and detail through use of the accompanying drawings, in which:

FIG. 1 includes a conceptual illustration of a system to provide one-action URL based communication and other services and management of such services through designated Ms;

FIG. 2A through 2C include conceptual illustration of various example sequences of how communication sessions may be established;

FIG. 3A through 3E include illustrations of example UIs for initiating communication sessions through various means;

FIG. 4A through 4H include illustrations of example UIs for viewing information, managing and configuring various aspects of communication services in a one-action URL based system;

FIG. 5 is a flow diagram illustrating an example flow of high level actions for one-action URL based communication services;

FIG. 6 illustrates major components of an example system for providing one-action URL based services and management of such services;

FIG. 7 illustrates a computing device, which may be used to manage one-action URL based services and management of such services; and

FIG. 8 illustrates a block diagram of an example computer program product, all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein. Additionally, the sequence of flow of the example embodiments may be changed depending on context of user scenario of specific embodiments.

This disclosure is generally drawn, inter alia, to methods, apparatus, systems, devices, and/or computer program products related to providing one-action URL based communication and other services and management of such services through designated UIs.

Briefly stated, technologies are generally described for one-action URL based communications and other services and management of such services through designated UIs. In some examples, URL based calling may be enabled for different communication modes using existing web browsers, components, and protocols without requiring the end users to employ special hardware or software. Indeed, to initiate a communication session, a requestor may not even have to identify themselves, create a user account, or log in to a service. Subscribers of the service may be provided dashboard UIs to manage their communications, communication and profile configurations, and communicate with other service subscribers. In mobile environments, where a browser may not be kept open continuously or the subscriber logged in, a mobile application may be used to automatically, without any user intervention, receive a request, activate a browser on the mobile device, and log the subscriber in such that the subscriber can receive the request, and accept the request or reject it and employ and benefit from other features provided by the service.

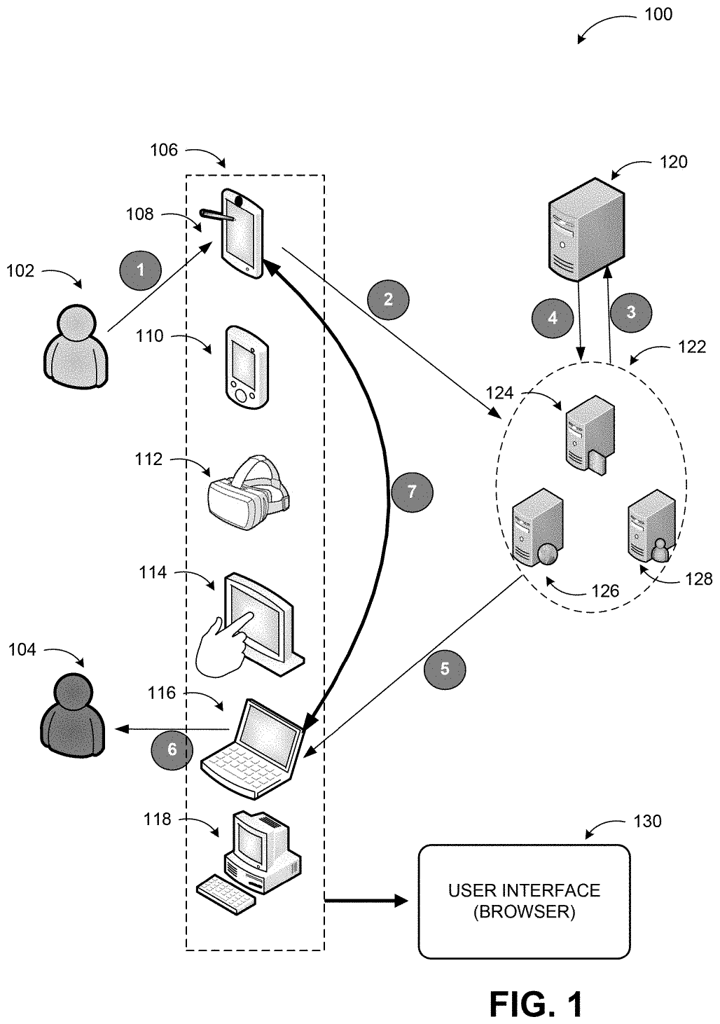

FIG. 1 includes a conceptual illustration of a system to provide one-action URL based communication and other services and management of such services through designated UIs, arranged in accordance with at least some embodiments described herein.

As shown in diagram 100, URL based communications may be established between users 102 and 104 using any number of devices and platforms. A system according to embodiments is application/hardware/location/browser-agnostic, that is the system does not require a specific application to be downloaded and installed on a specific device in order to facilitate communications. Furthermore, a system according to embodiments also does not require a web-application to be executed. If user 102 is initiating a communication session by sending a request, all that is required is a URL associated with the user 104 (a subscriber of a one-action URL-based communication service, a hardware device that supports a browser), any browser, and an active Internet connection. Thus, a variety of devices 106 such as tablet 108, smart phone 110, wearable computer (e.g., augmented reality glasses) 112, touch-enabled public computer display 114, laptop 116, desktop computer 118, and comparable ones may be used. Moreover, a system according to embodiments may be independent of location and allows the users 102 and 104 to be mobile while using the system. Thus, in addition to being agnostic to hardware device, operating system, browser, a communication service according to examples does not need a user to download an application. The communication service may be used in a point-to-point configuration as well as a mobile application and allow for seamless transition from stationary use to mobile use or visa-a-versa.

Various browser-based UIs 130 may be provided by the devices 106 to enable subscribers or non-subscribers to connect with subscribers, as well as, subscribers to manage their system, configure their options, etc. For non-subscribers, entry of a URL associated with a subscriber may bring up one of a number of preconfigured subscriber's home pages or profiles (e.g., their resume, their business information, etc.) and present options for the requested communication session such as which communication mode is desired. Moreover, the system may keep track of which requestors are presented with which home page, for example, an employment recruiter may be presented a professional home page while a client may be presented a company home page. Upon establishment of the communication session, the UI may present the communication (audio, video, text messaging, or others). For subscribers, various UIs as described below may present options to configure home page, communication options, view communication histories, etc.

Upon entry of the subscriber associated URL in the browser executed on device 108, the browser may forward the request to a server 120 that is configured to manage the service for its subscribers. The actual communication between the device 108 and the server 120 may involve interactions between server 120 and a number of other servers 122 such as proxy server 124, web server 126, real time communication server 128, and/or similar ones. Any communication protocol may be employed for the communications. Moreover, the communications between the devices may be facilitated over one or more networks, which may be public, private, wired, wireless, or any other kind including terrestrial or satellite-based systems or some combination thereof. Upon receiving the communication session request, server 120 may forward the request the subscriber (user 104) at one or more of the subscriber's devices such as laptop 116. The requests may be sent to any or all of user 104 devices, simultaneously or in a user defined sequence to any specific device or to multiple devices in a specific sequence, as may be configured in advance by user 104 (subscriber). In some examples, the user 104 may have to be logged in to their account in order to receive the communication session request (although being logged in is not necessary in the mobile embodiments). In other examples, user 104 may be allowed to configure their account to have requests forwarded to a specific device, during specific time periods, from specific requestors, or based on the assessment of the context of the requested communications, and so on. Users 102 and 104 may also be presented with options to select the communication mode. For example, user 102 (subscriber or non-subscriber requestor) may request a video call, but user 104 (subscriber) may only accept audio call or a text message session. Specifically, the users may communicate with each other based on their selected communication mode. For example, a requestor may initiate an audio call, while the subscriber upgrades this to a video call. Therefore, both can be within the same communication session in different modes of communications. In this example, the requestor may see the subscriber and hear his audio, while the subscriber may hear the requestor but cannot see their video. In other words, either participant may upgrade or downgrade their communication from text messaging, audio, video at any time and irrespective of what the other is sharing (system mode-agnostic). This upgrade feature may be extended to any users that subsequently join the communication session. Other controls available to the subscriber at the beginning and during the communication session may include, but are not limited to, muting or blanking audio and/or video modes of the communication session at either end. For example, the subscriber may mute their own audio or blank their video temporarily (or permanent). The subscriber may also be enabled to mute the audio and/or blank the video coming from the requestor at the subscriber's device at any point during the communication session.

Conventional technologies typically provide each subscriber with a static chat room and static identifier for that room. For conference services, the chat room identifier is generated and needs to be shared (manually or separately via phone, email etc.) with each potential participant(s) in order for them to join the conversation. Any participant that has or has had access to the chat room identifier can enter or leave the chat room whilst the chat room identifier exists. A previous chat room participant that retains knowledge of the chat room identifier can therefore engage in a future call by accident or for nefarious purposes. This approach may cause a number of problems in management, knowledge, system operations and security. For communication services, a caller needs to have a pre-established account, be logged in to search for others, send an invitation, and negotiate timing prior to initiating a conversation. Thus, a participant therefore retains no knowledge that may allow for the ability to participate in future communications or chat room sessions.

In contrast, embodiments provide at least following features: Discoverability (finding the right person to communicate with (within and outside of network)—a service according to embodiments may create a number of profile pages (personal, professional, business, etc.) accessible from a Personal identifier (URL of the subscriber), and any person may access any one of these profile pages provided they have the correct URL for that user (including non-subscribers or subscribers); Initiation (starting the conversation)—from the profile page, any person (including anonymous non-subscribers or subscribers) may initiate communication sessions (e.g., text message, audio, video, etc. sessions) by clicking a button (one-click calling); Notification (letting the subscriber know they have an incoming communication request)—the user, depending on the configuration of their incoming communication request settings, may be notified directly either via the browser, mobile application or mobile browser, or text messaging about incoming calls; Security/Privacy (only allowing authorized participants to join the conversation)—unique call rooms may be automatically or dynamically created each time a communication session is initiated and then removed (destroyed) when that communication session ends.

In some examples, a subscriber may be allowed to keep track (during Discovery) of which communication session requestor accessed which user profile. Thus, the subscriber may get page visit information through the dashboard including who accessed their page (or location if anonymous) similar to communication session history. The subscriber may employ built-in system features to sort incoming, outgoing, and missed communications based profile viewed by the requestor. In another example, the service itself may collect and analyze communication metrics (e.g. who initiated the communications, how many and who joined the communications, duration of communications, frequency of communications between any two users, quality of the communications, etc.) to develop a user profile, obtain user statistics, employ AI/machine learning algorithms to improve user experience and service automation, and/or allow for further development of enhances features.

In an example scenario, communication service (represented by server 120) may create a conversation offer (request) when a communication session is initiated. This may shift control to the recipient of the request (subscriber), so they can accept and manage incoming requests from non-subscribers or subscribers made to their personal identifier (URL). Based on the receiving subscriber's availability (which the subscriber may configure), the service may dynamically create a call room to which only authorized participants can be added and enter whilst the communication session is active. Once the communication session ends the unique call room may be removed and any unique elements pertaining to that specific communication session may be discarded and not reused or archived and retained for data mining purposes. Thus, participants from an existing communication session may not retain or be provided any information from the service that may allow their participation in any future communications session or chat session. Any new conversation offers may result in the dynamic creation of a new call room(s), on the fly, as needed to initiate a communication session. Thus, the subscriber may be provided with the ability to have multiple active conversations occurring at the same time on one (in different browser tabs) or multiple devices with reference to different user profiles as each conversation offer creates a unique call room. In a different embodiment, such multiple conversations may be linked or combined to bring together parallel communications. Furthermore, while a conversation is active, one of the participants may “jump off” on their current device and “jump on” using a different device without closing the existing conversation, for example, moving from a desktop computer to a mobile device in a car to continue the conversation.

In other examples, the communication service may provide the ability to provide a requestor generated context of the communication session within the communication session notification, which is displayed to the subscriber when the request is received. Generated context may be displayed in a number of forms such as text message, audio, video. For example, incoming request to the subscriber may be marked as “from Dad” with a subject “Medical Emergency please pick up”. Moreover, an artificial intelligence algorithm may be combined with machine learning engine(s) at the communication service may process provided contexts and provide additional features to recipients based on a number of communication metrics collected and analyzed including, but not limited to, communication history, communication session duration and communication frequency. For example, requests identified as emergency or urgent may be forwarded to the subscriber even if their availability schedule indicates their desire not to receive requests during that time period. The same may occur if the requestor is identified as family member or similar. A specific device may be selected based on the context of the communication session request, and many other conveniences may be presented to the recipients. In some cases, special interpretive directives or case and symbol sensitive predefined key words may be contained in the URL such as /JohnDoe/Call/Emergency that the service interprets as having a special or specific meaning (e.g. EMERGENCY, HELP, Pick-Up, WIFE, etc.). In such a scenario, the service may immediately provide the request to the subscriber regardless of their incoming communication configuration settings. A similar approach may be employed if the requestor includes special words, such as “emergency” or “Urgent” in their context. These commands may be thought of as a set of “contextual override actions” or “text interpreted actions”. The context may be provided by the requestor in the URL or following the submission of the request for the communication session (that is during the “ringing” phase when the session has not been established yet) through a UI displayed to the requestor.

While examples are described in conjunction with a communication service environment herein, embodiments are not limited to calling services. Specifically, one-action URLs, where a single URL defines a person, a subject or context, and an action, which is performed by a service upon entry of the URL in any browser may be implemented in a communication service or other platforms. In a communication service example, a URL may look like: url.live/johndoe/projectmeeting/videocall. A subscriber or non-subscriber may enter this URL into any browser in any device and be connected to John Doe for a video call with the subject project meeting. In another example, the URL may look like: url.live/janedoe/pay/500. Upon entry of this URL into any browser on any device, $500 may be paid from the person entering the URL to Jane Doe (for example, instructions may be sent to person's bank or the URL may be for the bank itself). In a further example, the URL may look like: url.live/JimDoe/IM/running 15 minutes late. Upon entry of this URL, a message may be sent to Jim Doe that the person entering the URL will be 15 minutes late (in this scenario, the person entering the URL may have to be a subscriber or otherwise identifiable). Further examples may include url.live/JohnDoe/ship/package1 (arranging delivery of a predefined package to a person), url.live/JaneDoe/deliver/file1 (transmitting a file to the recipient), etc., where designated terms may be used to initiate various actions with action parameters included in the URL. A user may be able to use a UI based menu with different URL identifiers to quickly configure and sort the system or send/execute specific actions that may be predefined by specific URL codes. For each of the various one-action URLs, a specific UI may be provided by the service allowing the actions to be performed while providing options and/or feedback to the users. In such cases, the sender of such action may be notified that the submitted action was executed and the communications service may record in its records specific details of the performed action (e.g., time, action, to whom, etc.).

Because the communication session, once established is directly between devices of user 102 and user 104, as opposed to facilitated by the server 120 (peer-to-peer), a quality of the communication session may not depend on server-related factors such as server's bandwidth, processing or memory resources, number of communications occurring at any given time, etc. Communication metrics may be captured directly on each user device and then uploaded to the server. After the communication session, the metrics and other call information may be archived at an archive server such that the data can be accessed subsequently to analyze the metrics. Yet, in other embodiments, for example when there are connectivity issues between peers or a large number of participants are needed in the communication session, the communication architecture may include user devices connecting directly to the server for the duration of the communication session. An availability feature provided with the URL based communication service may allow subscribers to define the time periods during which they are willing to accept incoming requests and during which they are not. Furthermore, the availability calendar may be integrated with other calendars or calendars that are specific to different third-party platforms that are used by each user in a communication session to automatically set available times. A subscriber may also respond to a requestor with an available/preferred time for the communication allowing the communication session to be set up for a particular time (and communication mode). In yet other examples, the timing and duration (and other parameters such as speaking time for billing purposes) for a group communication session may be displayed on the local device in the geographical local time of the requestor and/or the subscriber. Further, a subscriber may be enabled to request a report or generate a report from the communications service that specifically identifies, for example, how much time, how often, when communications took place with a specific subscriber, or associated with a specific project, or how often a subscriber was called between specific start and end dates, etc. Such reports may be used for consolidated billing, for taxations purposes, and similar ones (e.g., to demonstrate to parents when they say their children do not call enough.

In some examples, different user profiles may be linked to different integrated schedules. For example, a subscriber may accept requests on their personal profile outside of their business hours or they may accept requests coming in through their professional profile between 4 pm and 6 pm local time. Each unique profile may be linked with an associated web landing page with the ability to further link to other personal, private, or public websites. The landing page may also be changed based on the subscriber's schedule (for example, after business hours versus during business hours). For example, the subscriber's resume may be displayed as their default landing page during work hours and their personal page during non-work hours.

While subscribers can be reached by subscribers and non-subscribers through their dedicated URL (upon entering the URL, requestor is taken to a webpage, where they can select communication mode, provide context, and initiate the communication session), the service may also allow subscribers to provide access to their communication service through other public and private means (commercial means as well). For example, a “chat widget” code may be provided to subscribers such that a subscriber can import (e.g., copy and paste) the code into any existing website or when developing a website and allow others (subscriber or non-subscriber to seamlessly establish a communication session (video, audio, or text) with them through the widget. For example, a person named John Doe may take the dedicated URL urlive.com/johndoe/call, which may serve as the communication URL for contacting John Doe. In addition, the same person may have a personal website called johndoe.com. They may integrate the chat widget code into their personal website such that a button is displayed for anyone to request communication with John Doe using the communication service. Once a visitor to johndoe.com clicks on the button, they may be provided with the same options to initiate a communication session with John Doe as they would if they used the dedicated URL. The chat widget may also be integrated on third party, social network, professional network web pages and similar ones, where suitable. A similar widget process may also be placed on a retail website and may be used to allow for direct communications between an anonymous purchaser of a product and a company representative, for example.

According to yet other examples, a mobile application may be provided for use of the service on mobile devices. For a subscriber to receive communication requests, they may have to be logged in to their account through a browser. In mobile devices, the browser is typically not active all the time. Thus, requests may not be received on the mobile device unless the subscriber keeps the browser active and logged in to their account. The mobile application may include specialized application software that may activate a browser on the mobile device and log in to the subscriber's account automatically upon activation of the mobile application (one-click), thereby eliminating the need to activate or keep the browser active and logging in to the account manually.

Thus, a subscriber may only need a URL and a password to log in to their account and receive/manage communication requests. Non-subscribers may only need the URL to initiate a communication with a subscriber. While non-subscriber requests may be anonymous (unless the requestor provides their identity in the context), a general directory or a specific subdirectory based on message context may be provided of all subscribers as well as any non-subscribers that may wish to be listed. Furthermore, subscribers may be able to generate their own contact lists, groups, and teams, for which they may define/configure special features such as available times, request forwarding features, group communication features, etc. In a separate embodiment, the service may allow the subscriber to access or consolidate contact lists from other (third party) applications such as communication applications, calendar applications, social networking applications, and so on.

Following are some example embodiments in context of various use scenarios. In some examples, subscribers may be enabled to share a screen or a specific application user interface (i.e., desktop sharing or application sharing) with other participants in a communication session. Additional participants that may join the communication session subsequently may also be included in the shared screen or application UI. In other examples, subscribers may be enabled to record a communication session. The recording may include any utilized communication modes (audio, video, text messages), but also, any shared screens, applications, or even files. The recording may be stored locally on a subscriber device or on a back-end server. Participants of the communication session may be allowed to access the recording (e.g., playback for training, validation, confirmation, etc.) in its entirety or based on specified permissions. For example, as discussed herein, participants may be allowed to access portions of the recording and any additional data associated with the communication session based on a period during which they participated (and not other portions when they were not participating). Other permission levels (e.g., based on participant identity or credentials) may also be employed. In further examples, participants of a communication session may be enabled to exchange files through controls on the communication UI. For example, a side bar may allow participants to upload a file and transfer to all or selected participants of the communication session. The ability to transfer files may also be subject to predefined rules (e.g., based on participant credentials, whether the participant is anonymous, etc.). Transferred files may also be stored along with a recording of the communication session as described above. The service may collect usage, user data, and analytics as to such actions and use of screen sharing (e.g. whose screen was shared with whom, for how long, etc.), file transfer (e.g. what file was transferred, from whom to whom, size of the files, etc.), recordings (e.g. which communication session was stored, how long, who participated on the call, etc.).

A one-action URL as described herein may also be used to access and broadcast pre-recorded or other media to broad audience of participants that may include subscribers of the service (configured as individuals, in teams, or groups), and anonymous callers. For example, a presentation or a pre-recorded form a media (text, audio, video, desktop sharing, application sharing, augmented reality, virtual reality, or a combination thereof) may be broadcast by a subscriber or a server at a predefined time to an audience of participants. Audience may be provided with a one-action URL for the presentation ahead of that time and may be able to access the presentation by simply entering the URL into any browser. In other examples, the one-action URL may lead users to a UI, where they may be able to select among a plurality of presentations. The specific presentation to be accessed in the communication session may also be identified in the URL itself. For example, the presentations may be human resources training, product description, sales materials, lectures, etc. Thus, a communication session through a one-action URL may not be limited to human participants, but may also include communications between one or more humans and an automated entity. As described herein, the requestors of such communication sessions (with an automated entity) may be subscribers of a service or anonymous non-subscribers.

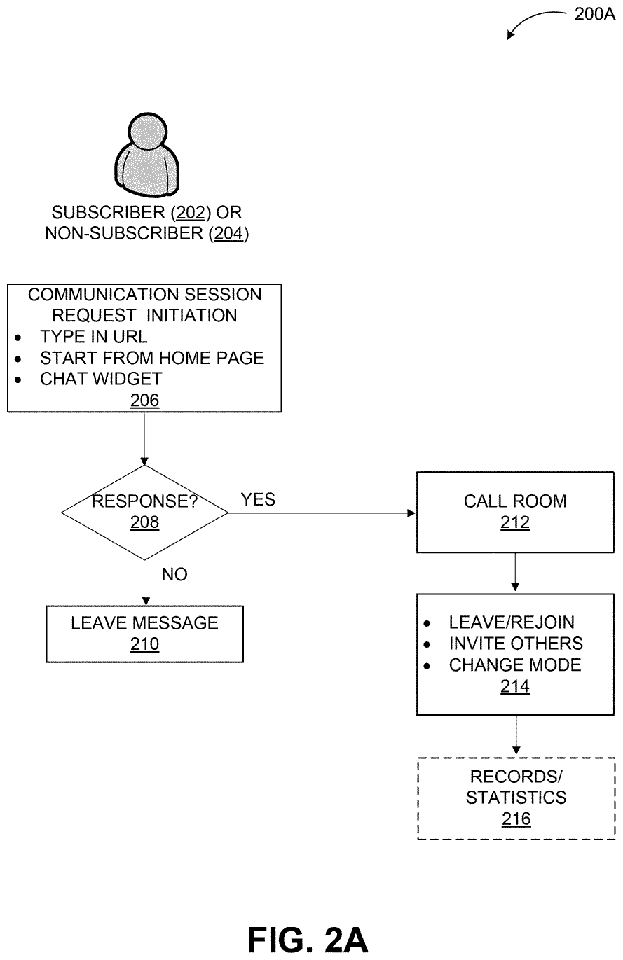

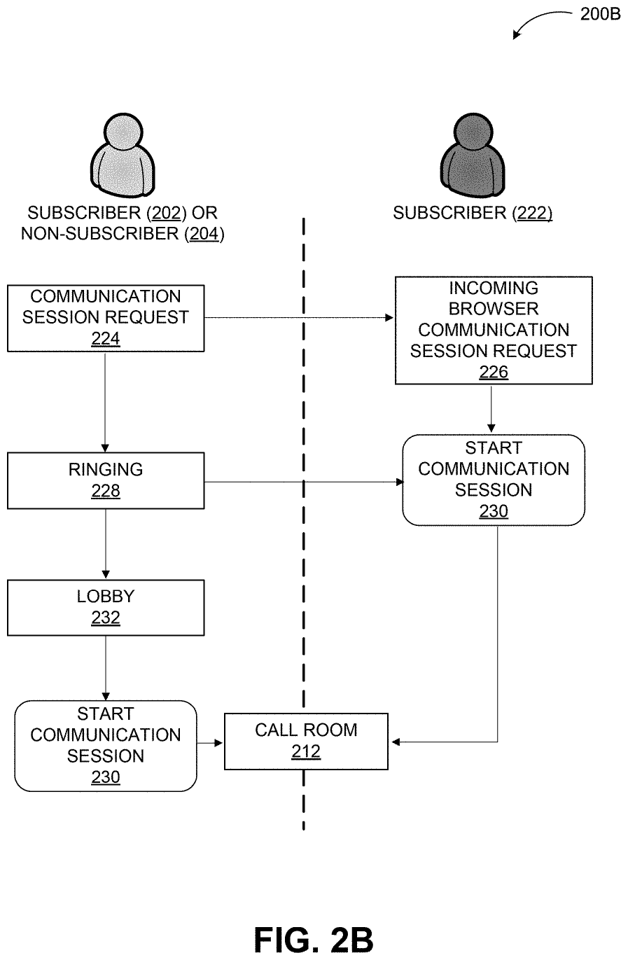

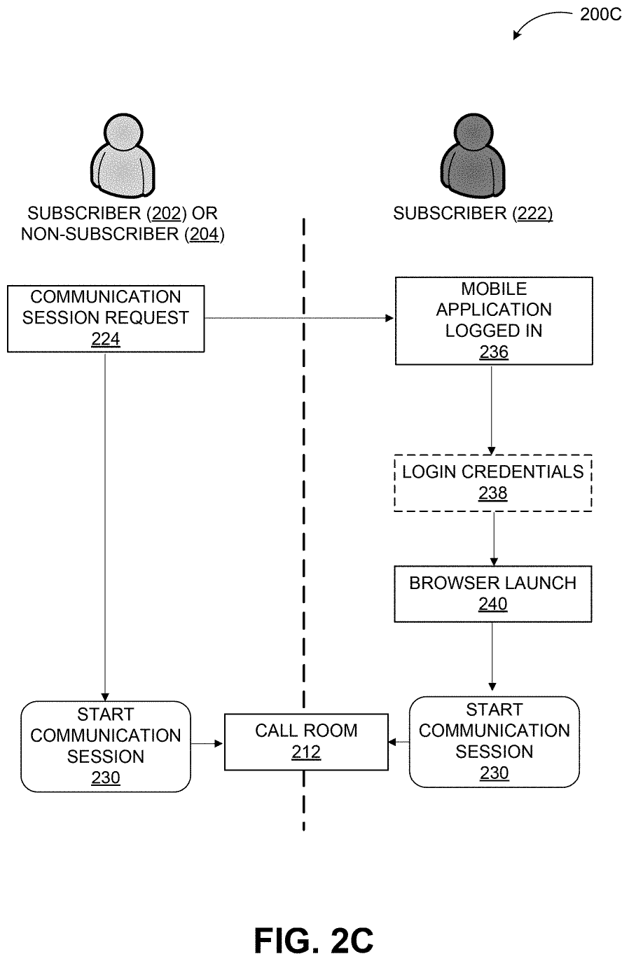

FIG. 2A through 2C include conceptual illustration of various example sequences of how communication sessions may be established, arranged in accordance with at least some embodiments described herein.

Sequence 200A in FIG. 2A shows events that start with a subscriber 202 or non-subscriber 204 initiating a communication session request (206) through typing a one-action URL in the address bar of a browser, activating a chat widget on a website, or starting the request from a dashboard of a personal service page (for subscribers). If the target subscriber does not respond (208), the requestor (subscriber 202 or non-subscriber 204) may be allowed to leave a message 210. The message may be audio, video, or text based. If the target subscriber accepts the request, the requestor and the target subscriber may be placed in a call room 212 to facilitate the communication session. The call room 212 may be created upon receiving the request (prior to subscriber response) in some examples. The requestor may select a desired communication mode. The subscriber may accept or modify the desired communication mode. During the communication session, the participants may leave and rejoin (through another device, location, communication mode, or browser), invite others to join the communication session (subscribers), and/or change the communication mode (214). Optionally, communication records and statistics (communication metrics) may be kept by the individual devices and/or involved server(s) and collected at the end of the session by the server to be stored at the server, at another server, or at one or more of the involved user devices.

In some embodiments, web real time communications (WebRTC) protocol may be used to establish and facilitate the communication session between the users' devices. However, embodiments are not limited to WebRTC and may be implemented using any suitable protocol. Furthermore, requestor and target subscriber may use the same or two different browsers. Indeed, if the subscriber uses multiple devices during the communication session (e.g., the “jump off”, “jump on” process discussed herein), they may use different browsers to continue the communication session from different locations and may rejoin the communication session provided that at least one participant remains in the communication session.

In an example scenario, the communication session may continue until the last participant leaves. Thus, the communication session may theoretically be a never-ending communication session. The last participant to leave may be the original initiating requestor or the target subscriber. In other examples, any participant (e.g., later invited participants) may be the last “participant” and the call room 212 may remain active until everyone leaves. However, while subscribers may leave and rejoin a communication session while the communication session is active, anonymous requestors may not rejoin a communication session once they leave. But if a subscriber is the requestor, then the subscriber may rejoin the communication session as long as it is active. In summary, all subscribers may rejoin a communication session as long as it is active. Non-subscribers, who are always requestors and never recipients of requests, may not rejoin a communication session once they leave. In some embodiments, if a non-subscriber is provided with a specific URL associated with a communication session, they may rejoin the communication session one or more times.

In another example scenario shown in diagram 200B of FIG. 2B, subscriber 202 or non-subscriber 204 may submit a communication session request 224, which may be forwarded to the target subscriber 222 as incoming browser communication session request 226. As the request is forwarded and the subscriber 222 is being notified, the subscriber 202 or non-subscriber 204 may be notified about ringing 226 until subscriber 222 accepts the request and starts the communication session (230). The subscriber 202 or non-subscriber 204 may be placed in a lobby 232 and remain in the lobby 232 until the communication session is started (230). In some embodiments, requestors and target subscribers may be automatically moved through the lobby. While requestor is in the lobby, the requestor and/or the target subscriber 222 may setup the audio-visual controls through a presented UI before starting the communications session. Such audio-visual controls may include the ability to turn on or off audio or video controls and select or switch between camera's, microphones and audio output devices. The subscriber 222 or requesting subscriber 204 may at this stage, add other participants (subscribers) to the communication session. While in the call lobby, subscribers may see which other participants are present and be able to simultaneously message one another before the communication session starts and while the communication session is ongoing provided they have not left the communication session. Once the controls are set up and the target subscriber 222 has accepted, and any participants invited, initiating subscriber 202 or non-subscriber 204 may start the communication and begin in call room 212. Once in call room 212, any of the subscriber participants may invite other subscriber participants (i.e., establish multiple communication sessions concurrently).

In some examples, the communication sessions facilitated by the communication service may comprise two different channels for communication. The first channel may be for audio/video exchange. The second channel may be used for setting up the audio/video call and also for text messaging. Thus, two independent, but synchronized, channels—one for text and one for audio and/or video communications may be provided. The text messaging channel may be designed to be independent of the other audio/video channel and robust to ensure that at any point during the communication session, the participants may be able to communicate with each other via text messaging. For example, the second independent channel may be used in the case where WebRTC channels may fail. This may assure that communication via audio, video or text messaging is never lost in a communication session because it can be quickly re-established. The robustness of the second channel may be achieved by using a separate protocol from the WebRTC, such as one or both of websockets or hypertext transfer protocol (http). Security protocols for communications may be updated and increased manually using separate security overlays or configured to be updated based on on-going improvements imposed by WebRTC or browser protocols. In a separate embodiment, each of the video, audio, or text channels may be designed to be independent channels of communication that are integrated to seamlessly work together via synchronization software implemented at the back-end.

Diagram 200C of FIG. 2C shows implementation of a system according to embodiments in a mobile environment. Subscriber 202 or non-subscriber 204 may send a communication session request 224 through one of the methods described herein. Target subscriber 222 may use a mobile application 236, which may need only one download and activation or for the subscriber to be logged in to work. In case of log in requirement (e.g., for security purposes), the subscriber 222 may provide their login credentials 238 for a predefined period of time, any time the mobile device is turned on, or based on a similar scheme. Upon receiving the communication session request 224, the mobile application may launch (240) a mobile browser on the subscriber's device and start the communication session (230) by placing both participants in the call room 212.

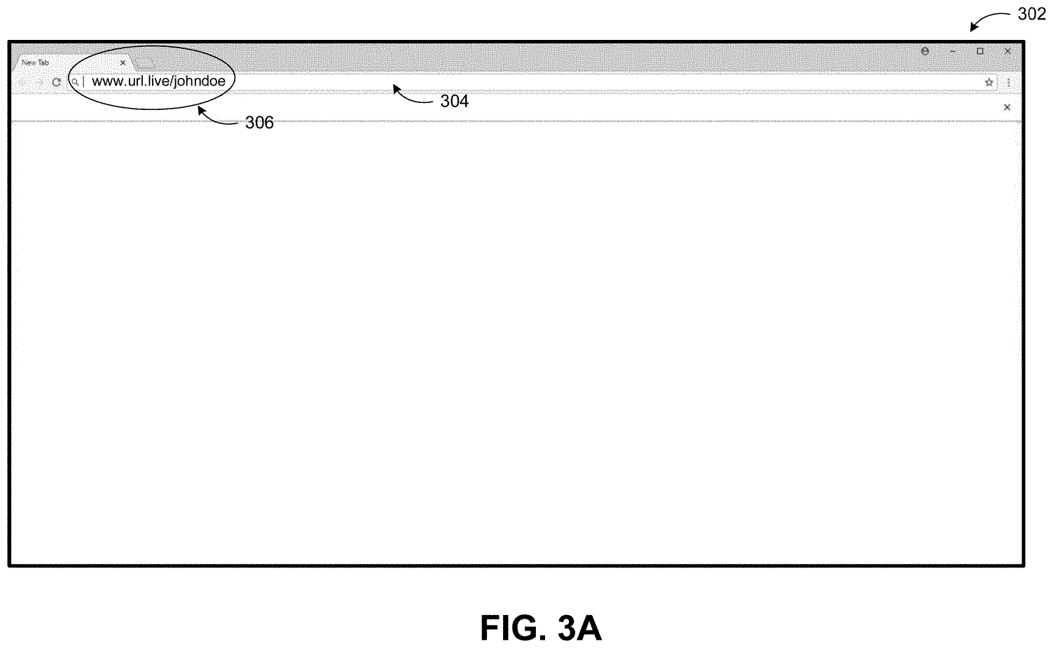

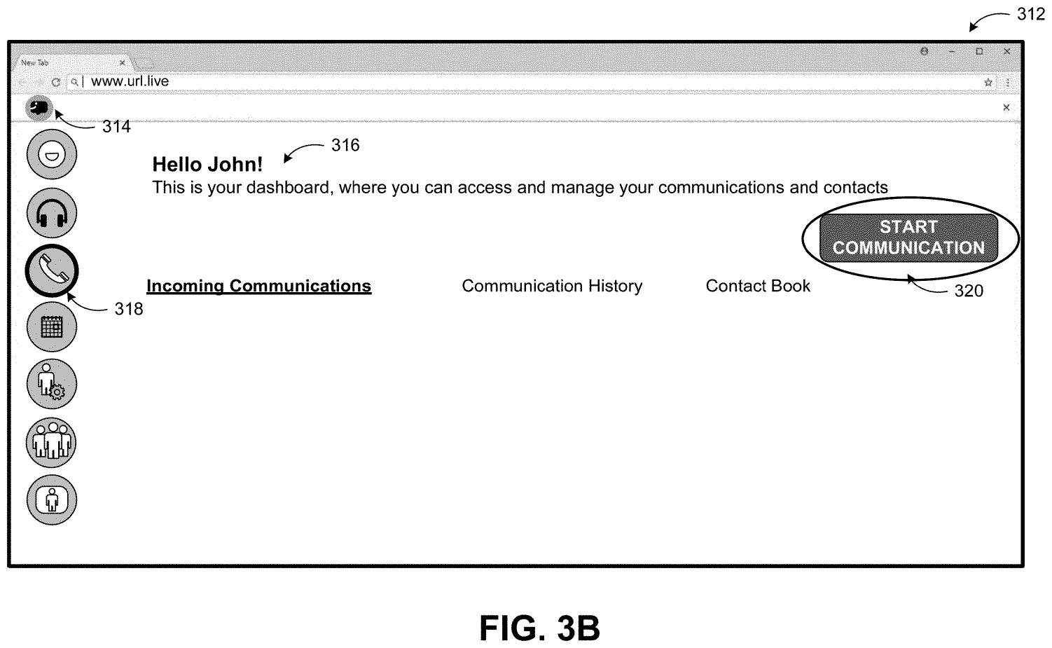

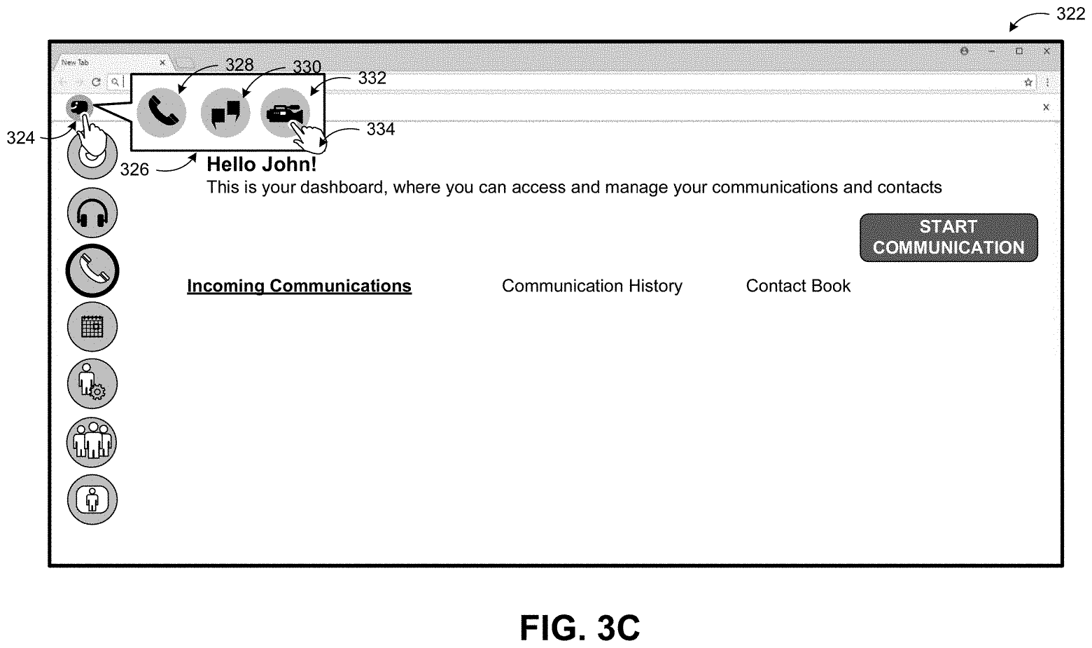

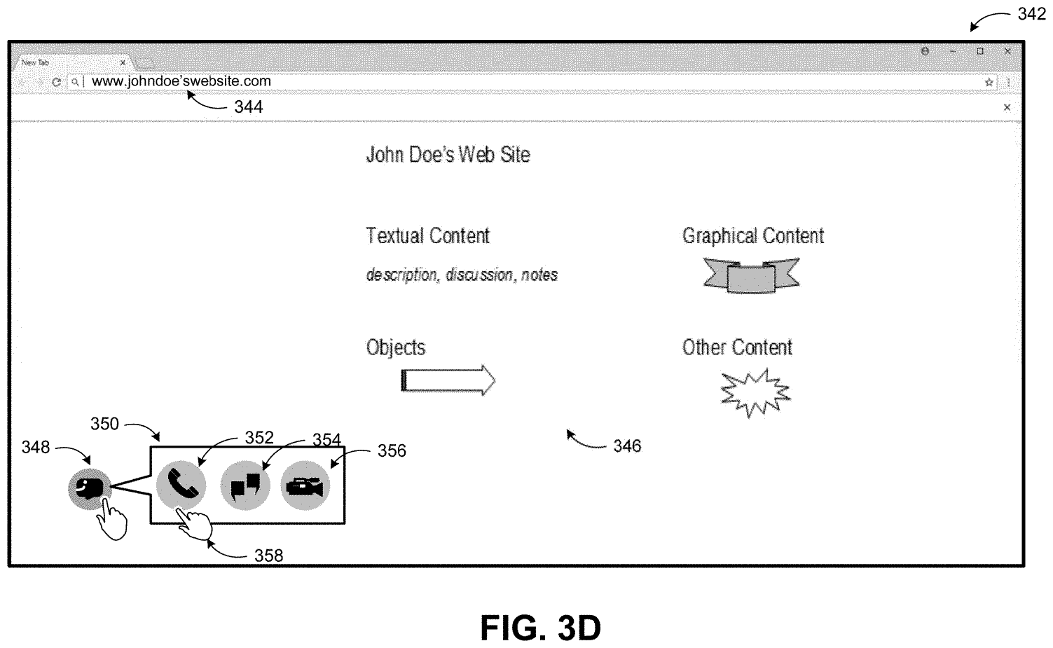

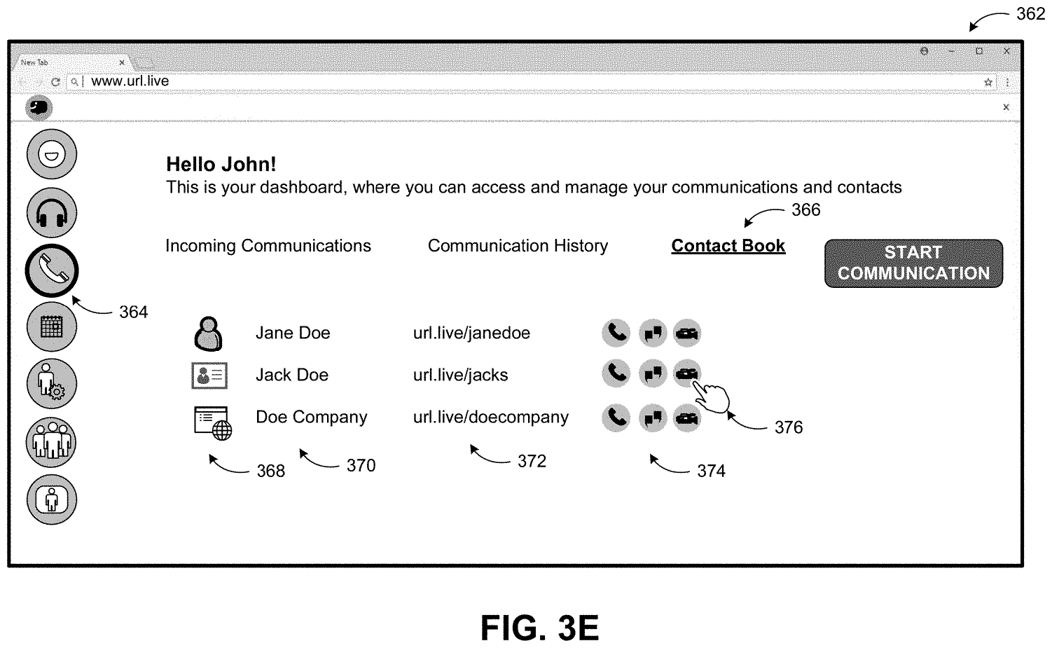

FIG. 3A through 3E include illustrations of example UIs for initiating communication sessions through various means, arranged in accordance with at least some embodiments described herein.

Example UI 302 in FIG. 3A shows one alternative for initiating a communication session in a system according to embodiments. Subscribers of a one-action URL based communication service may be provided with a URL 306 (e.g. their name or any other alphanumeric URL and the action term such as “call”), which any requestor may enter into the address bar 304 of a browser and initiate the communication session. In other embodiments, where other services such as messaging or payment services may be provided, the one-action URL may identify the target subscriber and the service to be provided (message or payment amount).

FIG. 3B includes UI 312, which is an example of another alternative, the dashboard of subscriber's home page with the service. The subscriber's homepage may provide various pages or tabs to perform different functions or provide different types of information such as incoming request configuration, communication history, etc. Such pages or tabs may be accessible through controls such as dashboard control 318. A navigation button 314 may also provide functionality associated with navigating through different functionalities of the subscriber's homepage. While the dashboard may display additional information such as greeting message 316, incoming communications, communication history, contact list, etc., it may also include a control element such as button 320 that initiate a communication session with another subscriber. Upon activation of the button 320, a UI may be presented to enter the target subscriber's name or select from a list of subscribers.

FIG. 3C illustrates example UI 322, which is yet another alternative for initiating communication sessions. This alternative for initiating communication sessions is through the use of the dual-purpose navigation button 324. The dual-purpose navigation button 324 may display a badge 326 upon activation. The badge 326 may include representations (e.g., icons) for different communication modes such as audio 328, messaging 330, video 332. Upon selection 334 of one of the presented communication modes, a UI may be presented to enter or select a target subscriber and a communication session request may be sent to the target subscriber. In some examples, a subscriber may be allowed to move (copy) the dual-purpose navigation button 324 onto their desktop, for example, through a drag-and-drop action. Upon being moved to the desktop, the dual-purpose navigation button 324 may provide same or similar functionality as the same button when it is displayed on the browser UI. For example, the navigation button may act like a mini communication controller providing similar functionality such as displaying/accepting/rejecting incoming requests through a badge, taking the user to the dashboard by opening the browser, etc.) as on the user's service page.

FIG. 3D shows example UI 342 with further examples of initiating communication sessions according to some embodiments. As discussed previously, subscribers may be provided code for a chat widget, which they may integrate into their website 344 (or any other website such as their social networking page, professional networking page, etc.). Thus, the UI 342 is not of a homepage of the subscriber with the communication service, but the UI of a subscriber's own website, for example. The example UI 342 may include content 346 associated with the subscriber or anything else for that matter on the website. The chat widget 348 may be displayed on any location designated by the designer of the website and allow communication sessions to be initiated upon activation. When a person is visiting the web page that includes an integrated chat widget 348, they may click on it and be presented with options for communication modes on badge 350 such as audio 352, messaging 354, video 356. Once the communication mode is selected 358, a communication session request may be forwarded to the subscriber associated with the chat widget. In another embodiment, the URL line may be mimicked in another part of user interface screen or menus to increase text size, be proxy text for the actual URL text, and the like.

FIG. 3E shows example UI 362, which is another method of initiating communication sessions for a subscriber. As discussed above, subscribers of a communication service according to embodiments may be provided with multiple pages or tabs to manage their service and communication sessions such as dashboard 364, which may include a list of incoming communication requests, a communication history, or a contact list 366. The contact list 366 may provide a listing of the subscriber's contacts in a variety of forms (e.g., tabular list as shown in FIG. 3E, card form, or comparable forms). The example tabular form may provide icons representing a type 368 of the list entry (e.g., person, company, other entity), the list entry's name 370, their one-action URL 372, and available communication modes for each list entry 374. The available communication modes 374 may be static (e.g., a person may only accept audio communication requests) or dynamic (e.g., depending on the device or platform used by the person at any given time, the available communication modes may change). Upon selection 376 of a particular communication mode for a particular contact list entry, a communication session request for the selected mode may be forwarded to that person/company/entity. In some examples, subscribers may be allowed to import or synchronize their contact list with other contact lists from other applications, or contact lists across applications/platforms may be synchronized automatically.

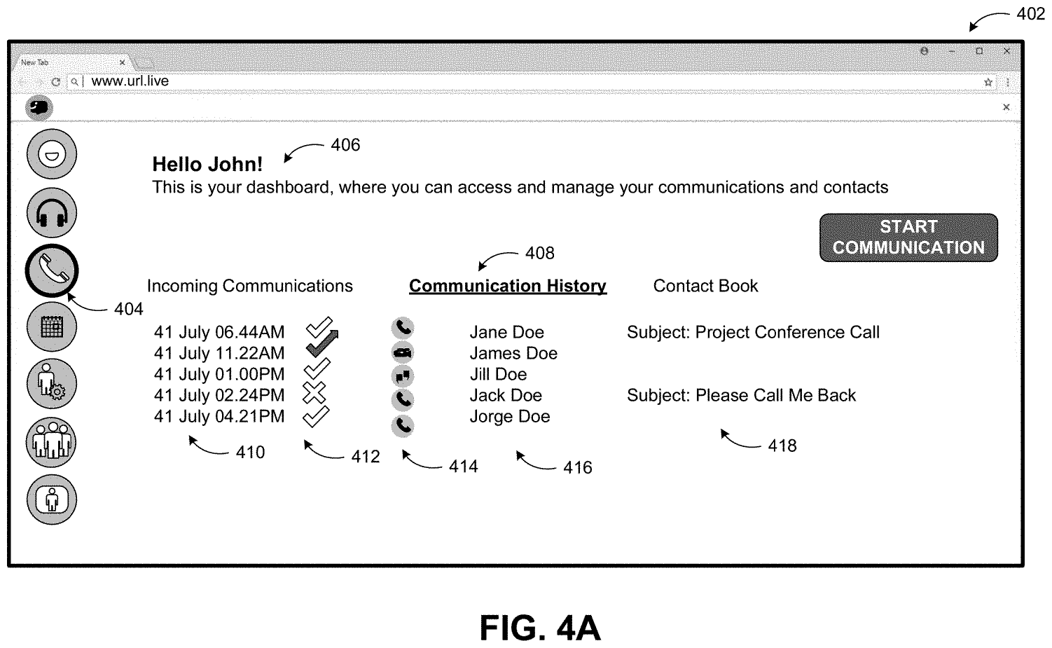

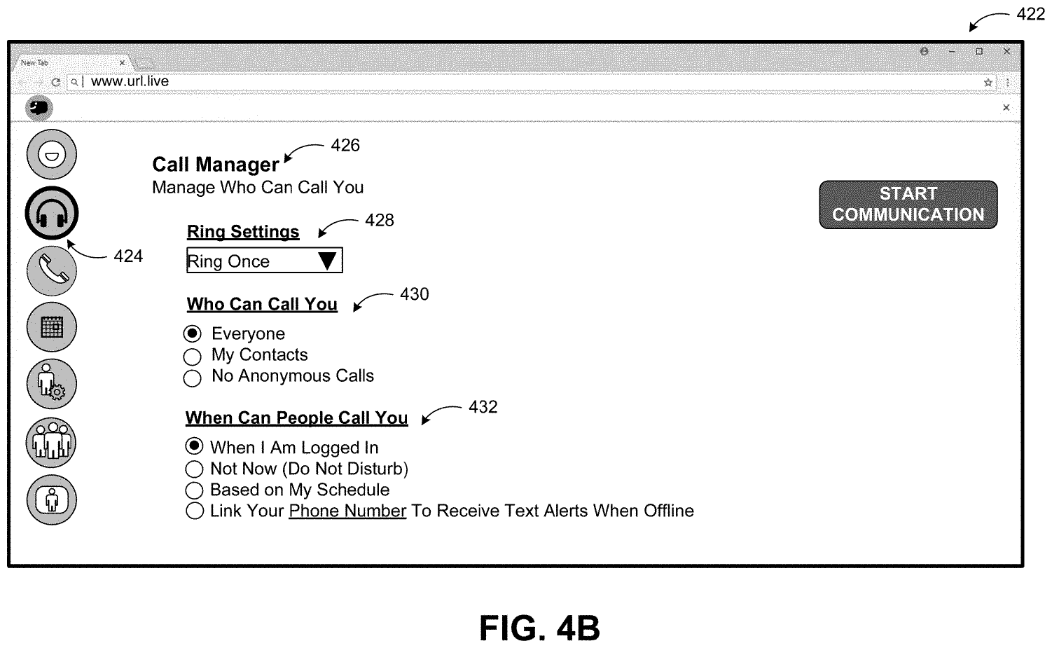

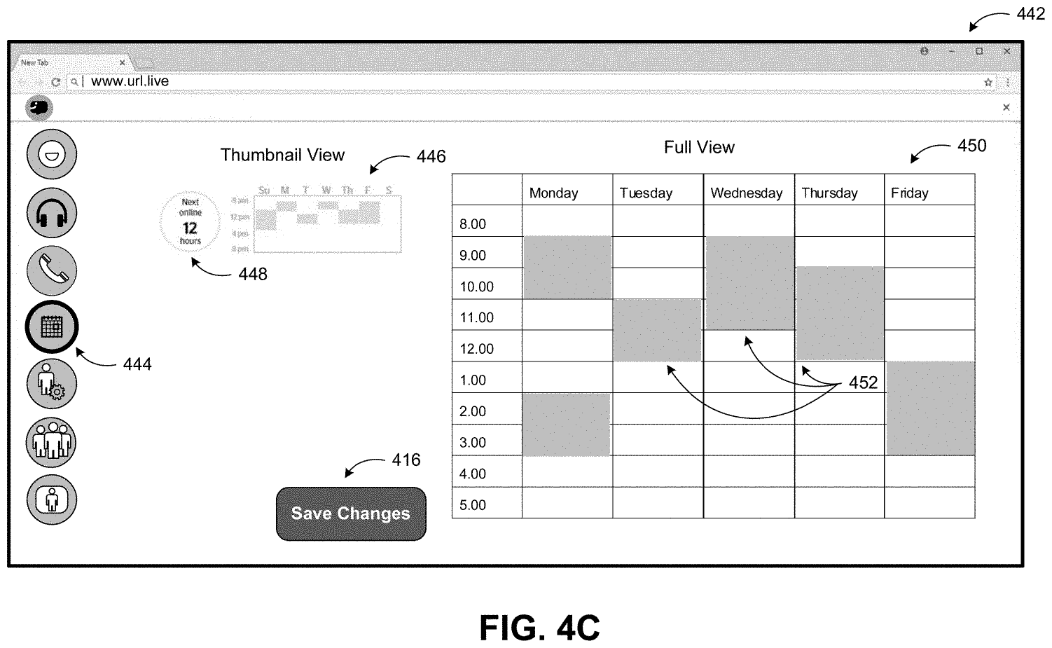

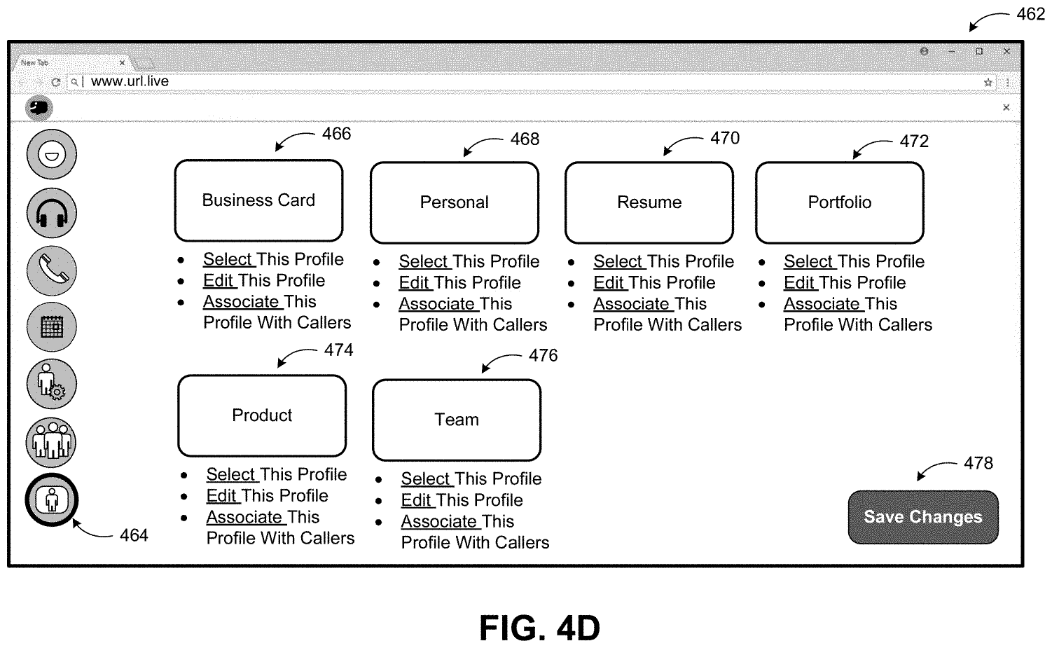

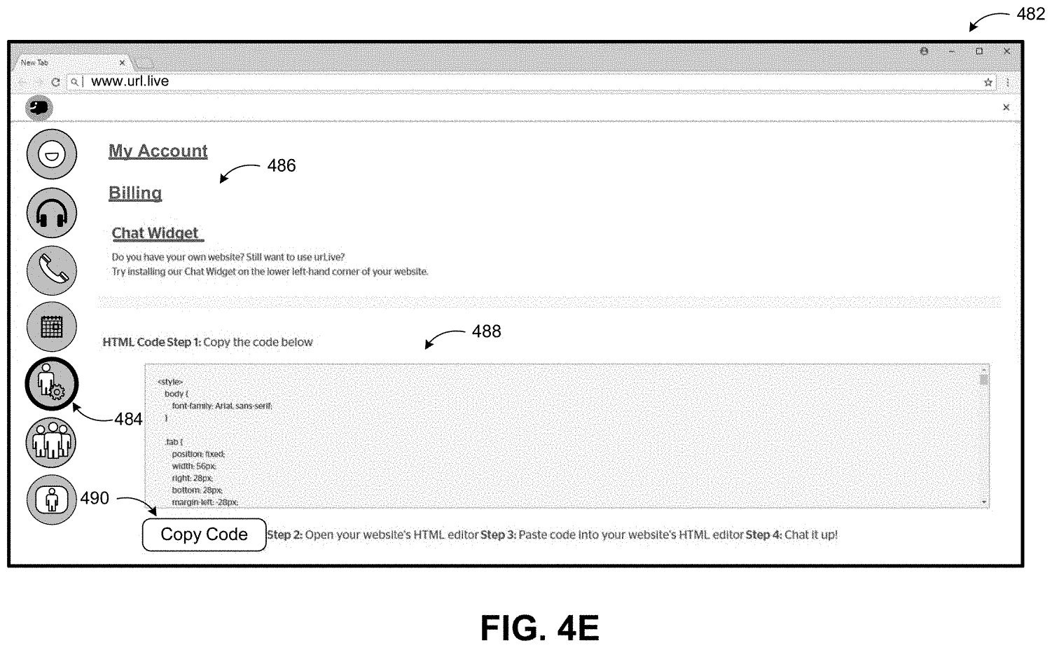

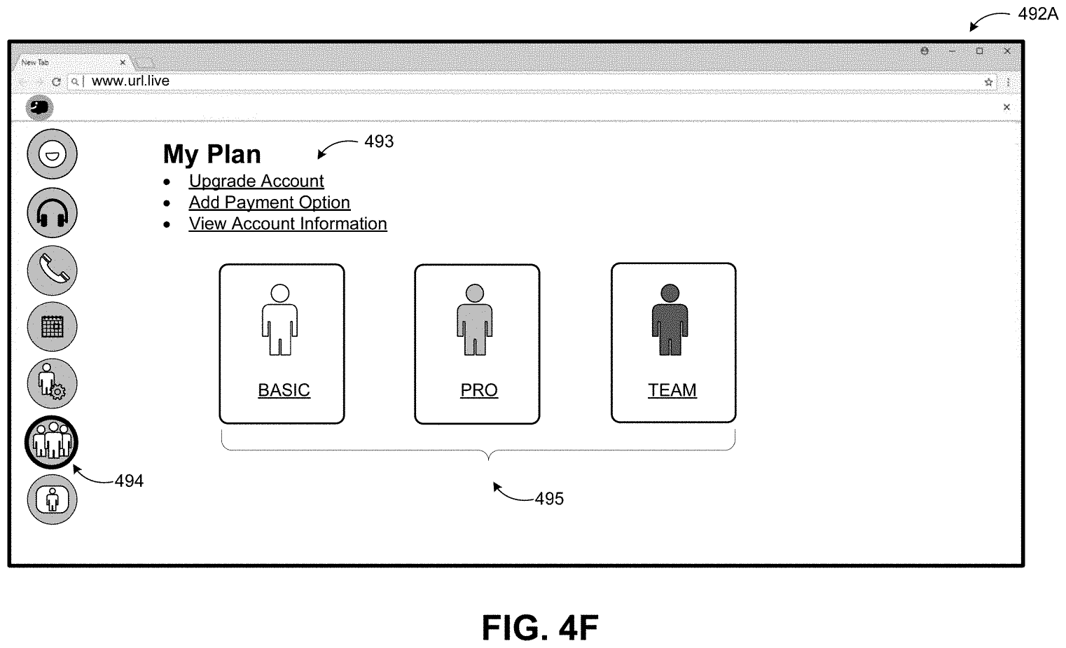

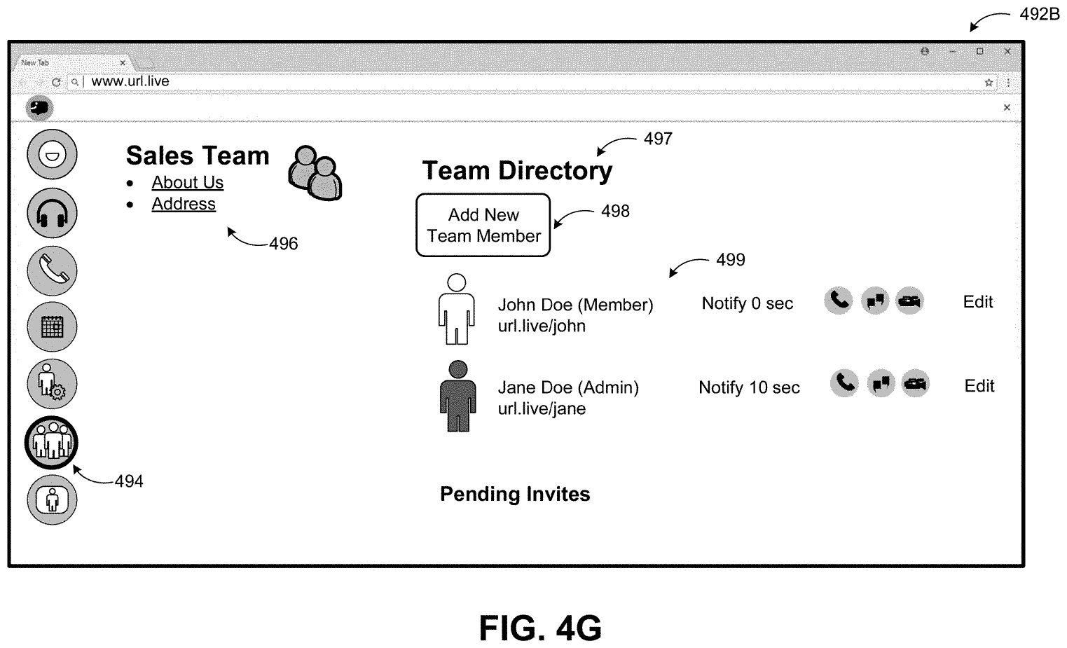

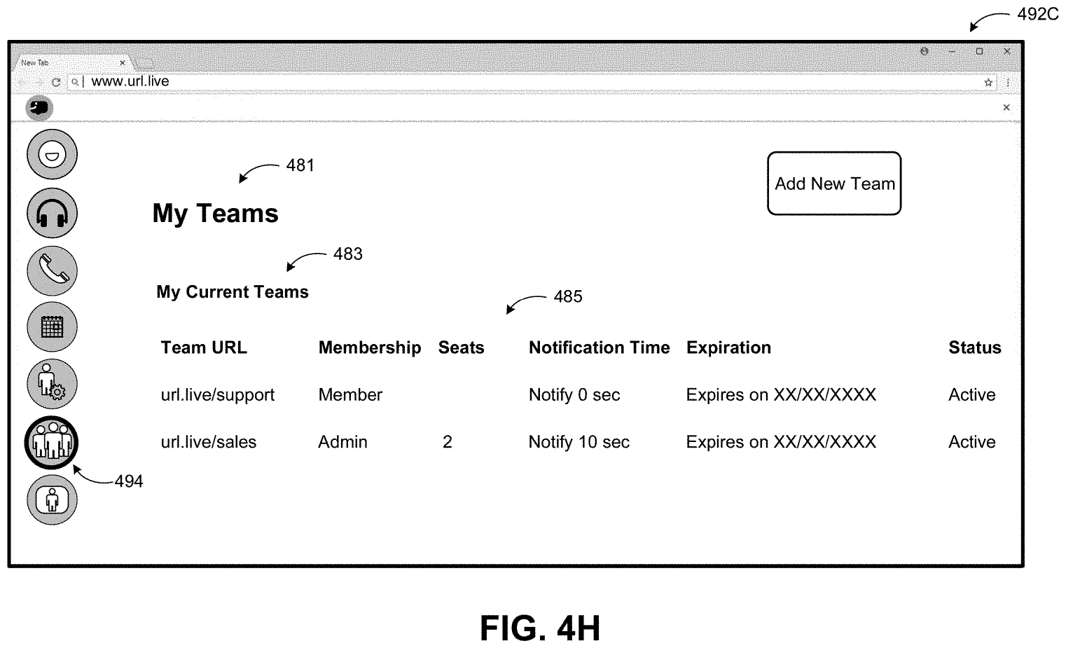

FIG. 4A through 4H include illustrations of example UIs for viewing information, managing and configuring various aspects of communication services in a one-action URL based system, arranged in accordance with at least some embodiments described herein.

Example UI 402 in FIG. 4A shows the dashboard of subscriber with communication history 408. As mentioned previously, the dashboard UI may be a portion of a larger page for the account holder, where options to visit other pages such as scheduling page, configuration page, teams page, etc. may also be presented. the dashboard may be selected among other available pages or tabs for various aspects of the service through a control element 404 and present a greeting message 406 indicating to the subscriber what can be done through the dashboard. The dashboard may also include a listing of incoming communications and a contact list. If the communication history 408 is selected, past communications may be listed according to names of participants, dates/times, or other properties. In the example UI 402, the communication history is provided according to chronology listing dates and times 410 for each past communication session. Indicators 412 may represent if a particular communication session was held, was forwarded to someone else, or was rejected. Mode indicators 414 may display (graphically or textually) which communication mode(s) were used in each session. Names of the requestors or other participants 416 may also be listed. A context column 418 may display context such as subject of a communication session if one is available.

In some examples, an artificial intelligence engine or similar machine learning method may be used to determine the most relevant people to suggest to the subscriber to prioritize which incoming call to receive first. The presentation schemes (e.g., color, textual, highlighting, etc.), icon functionality, and design layout of any UI may be altered in all cases and without loss of functionality to emphasize a specific usability aspect of the service, or to address the needs of specific market or customer base. Navigation of the UI may also be performed using voice command or gestures and may further be integrated with voice commands or other input mechanisms that are linked with the system or with a third-party voice-based assistant. Because a platform according to embodiments is web-based and driven by common databases any change made on one platform configuration may be incautiously available on the other user platforms (desktop, pad, mobile . . . etc.). Furthermore, the page may include a quick call button, search options, alerts, and quick configuration options. By clicking on other subscribers' name or one-action URL, the subscriber may be presented with options to go to their placed calls, their home page, their account information, or an option to log out from the service.

FIG. 4B shows example UI 422, which is an example of a call manager page 426, where the subscriber may select configuration options for their communication sessions such as ring settings (e.g., how many times or how long an incoming request should ring (428) before being directed to voicemail or text message), who is allowed to send requests to the subscriber 430 (e.g., anonymous requestors, selected groups of people, all service subscribers, etc.), when the subscriber accepts communication requests 432 (e.g. logged in, not now, or at specified days and times), and similar configurations. Other parameters associated with incoming requests may also be presented and configured on this UI either by default display or by customization of the UI by the subscriber.

FIG. 4C shows example UI 442, where a subscriber may select/define their available times for incoming communication requests. The scheduling page may be selected among other pages through control element 444 and display a calendar view 450, where the subscriber may select specific times and days to indicate their availability to accept communication requests (or non-availability). The page may also show a thumbnail view 446 of the subscriber's schedule, which may be presented to other people (subscribers or non-subscribers). Another way the subscriber's availability may be presented to others is the “next available” element 448. At any given day or time, the system may determine when the subscriber is available next based on their schedule and display that graphically and/or textually. For example, the subscriber may have blocked off the rest of a particular day and have the first availability the following day at noon. If the current time is noon on the blocked off day, the “next available” element 448 may display “24 hrs”. Other scheduling formats may also be used to allow the subscriber to identify their available times. Furthermore, the subscriber's calendar(s) in other applications or platforms may be synchronized with or used to determine the availability automatically. In some examples, the service may interrogate both the subscriber's schedule and the requestor's schedule (if the requestor is not anonymous) to find the next free available time when both the subscriber and requestor are available for a communications session. The service may also provide the subscriber and/or the requestor with a text or email reminder notification of pending communication sessions and prescheduled communication sessions. A text message notifying the subscriber about the communication session request may include, in some examples, a link to start a browser and optionally to let the subscriber log in to their account automatically. If the requestor is a subscriber or otherwise known (not anonymous), the notification text message may include the identity of the requestor. Further, the service may automatically identify times within the subscriber's schedule when the subscriber is no longer available because a previously open time slot (within available times) may have been taken by someone else. In other examples, subscribers may be enabled to set time slots to minimal units such as 10-minute intervals. Using the collected data and communication system analytics, an AI system may automatically recognize that a previously allocated time for a communication session has become available because the communication session was terminated, for example, and the system may automatically adjust the subscriber's schedule to show “available” under such a scenario.

FIG. 4D shows example UI 462 for selecting and configuring a subscriber's profile pages, where the subscriber may select among preset profile display options and then be prompted to provide information for the selected profile option. The profile management page may be selected among other pages through control element 464 and present a number of preset profiles 466, 468, 470, 472, 474, and 476. The present profiles may be based on general market needs such as “Business Card”, “Personal”, “Resume”, “Portfolio”, “Product, and “Team”, or based on specific specialty needs (e.g., for legal profession, for medical profession, for service providers, etc.). The presented profiles may also be dynamically selected based on subscriber attributes. If the subscriber is a marketing person, a set of suitable profiles may be displayed, whereas for a subscriber that is an engineer, a different set of profiles may be displayed. Subscribers may be enabled to change their displayed profile at any time. Upon selecting a profile and/or editing profile information, the subscriber may be allowed to publish that profile by clicking on a “Save Changes” button 478, for example. Subscribers may also be enabled to select different profiles for different requestors. For example, anonymous requestors may be directed to one profile, while others may be directed to another profile.

In an exemplary embodiment, each subscriber may have a unique user profile. The user profile may be hidden from or visible to the public. A non-subscriber may remain anonymous while viewing a subscriber's user profile. A user profile may include any information at the subscriber's discretion. For consistency purposes, the user profile may draw from a common set of profile data fields. The data fields may not all have to be filled out and completed by the subscriber and may be completed over time at that subscriber's discretion. For example, the fields may comprise the subscriber's birthdate, home town, employer name, images, marital status, telephone number, email address, favorite sports teams, music groups, people, or other interests, links to other third-party profiles such as social or professional network profiles or other non-public websites. The subscriber may be allowed to create and access any number of user profiles, each specifically designed to address expectations of a specific anticipated audience. For example, a subscriber may have a professional, personal and business profile, all drawn from a common set of previously input information and may have the capability to direct a specific profile to specific communication requestors based on the analytics and the Internet address of the requestor.

In some examples, subscribers may have multiple profiles based on their user ID. The multiple user profiles may stem from a base default profile. The base default profile may be linked to pre-stored profiles within the account of subscribers. When a change in data or information in any one of the subscriber's profiles is completed, the change in data or information may be updated and reflected in the other profiles of the same subscriber. The base default profile may also be linked to other services outside of the subscriber's account. For example, the subscriber's account may be linked to their respective social network(s), professional network(s), and social media sites. In other embodiments, the subscriber's profile may be linked to sites of other subscribers and non-subscribers. In addition, the user profile represents a dynamic web presence of the user which can evolve and be refined and updated over time, all at the subscriber's discretion.

In yet other examples, a subscriber may have multiple profiles active at the same time. For example, they may specify a default profile such as their resume, which may be active at their default site (e.g., url.live/johndoe). However, the users may still be able to access their multiple other profiles by simply specifying which one, for example, url.live/johndoe/personal, url.live/johndoe/portfolio, or even, url.live/johndoe/resume). In this manner, someone may print business cards with url.live/johndoe/resume which displays their resume, even if they specify that their default profile at url.live/johndoe displays their portfolio. According to some embodiments, a subscriber may be allowed to define personalized terms such as “resume”, “personal”, “portfolio”, etc.

FIG. 4E shows example UI 482 for configuring various options associated with the subscriber's account. The account configuration page may be selected among others through the control element 484 and display configuration options such as account information, billing, etc. The account configuration page may also include a chat widget portion 486. The chat widget portion 486 may display chat widget code 488 (e.g., in HTML) to allow the subscriber to copy the code to any web page such as their personal or professional web page, a social network page, a professional network page, etc. A copy button 490 may allow the subscriber to copy the code into cache memory in one click to make it easier for the subscriber to paste the code into the other web page. As discussed above, any person visiting the website with the chat widget may initiate a communication session to the subscriber by clicking on the displayed chat widget. The chat widget may also be used to display the subscriber's service profile on the website, where the widget is displayed. The chat widget may allow the subscriber to select which (or all) communication modes to be made available to requestors. Thus, the functionality associated with the chat widget may change based on subscriber configuration. For example, the subscriber may select certain communication modes to be available based on timing, IP address of the requestor, website on which the chat widget is displayed, or comparable parameters.

All UIs presented above are exemplary for illustration purposes and are not intended to limit embodiments. The one-action URL based service functionality described herein may be implemented using other UIs, UIs with modified portions, graphical or textual elements, and other presentation schemes.

According to some embodiments, subscribers may be enabled to form teams, that is multiple accounts joined as a team and associated functionality. FIG. 4F through 4H show various UIs associated with viewing and managing teams functionality. Example UI 492A in FIG. 4F shows how a subscriber can view options for different account types 495 and select among different account types including one that allows for formation of teams. Teams accounts may also have different levels allowing different numbers of teams or team with different levels of members to be created. The account configuration page may also include configuration options 493 such as upgrading the account, adding payment information, viewing account information, etc. Teams functionality may encompass any groupings. For example, study groups, family members, friends, social groups, professional groups, etc. may be the basis for a “Team” in a system according to embodiments.

Example UI 492B of FIG. 4G shows an example team (Sales Team 496) with links to information about the team, team address, a graphic representing the team, etc. Team directory 497 may provide a listing 499 of current team members with their names, URLs, notification options, communication mode options, and an option to edit each team member. A control 498 may also be provided to add new members to the displayed team. In some examples, an administrator may add, subtract, remove, or designate any other member as an administrator. Potentially every member may be an administrator (there may be no restriction on the number of administrators in a team). An administrator may invite another user to the team as either a member or an administrator. An administrator may remove and manage any other administrator or designate any other member as an administrator. The team may always have at least one administrator at any time (potentially everyone on the team may be an administrator). A member may remove himself or herself from group through the configuration UI. When a request for communication session is directed at a team, the requestor may be presented with a UI that presents team members along with communication mode options for each team member or the entire team. Thus, the requestor may choose to request communication directly with a specific team member or with the team, which would be subject to the sequence rules defined by the team (a team administrator). Team members may see in their incoming calls UI whether an incoming request is directed to the team or directly to them.

A member of the team may accept or decline an invite to the team, may at any time remove themselves from the team, and may change their notification time for incoming team calls (e.g., Not Notify, Immediately Notify, based on Time Delay notification). No additional sign in may be required to administrate or manage the team in some examples. Mutual acceptance may be needed to become a member of the team—even though an administrator invites a user to join the team the user must agree to become a team member/administrator. The system may capture metrics associated with a communication session or a number of communication sessions between two designated times and generate a report of summary metrics that may include who participated, how often, how many communication sessions, total duration of communication sessions, etc. Such a report may be available to a team administrator to understand the extent of participation that any or all team members have had during the progression of a project, for example.

An administrator of the team may edit and manage the team page (change image, title, description), may add more ‘seats’ to the team, may change subscription term, set the method of payment and pay for the team, may deactivate and reactivate the team, may invite users as members or administrators to the team, may remove users from the team, may upgrade an existing team member to an administrator, or may change the notification times of each user and setup the sequencing of incoming team calls. Any designated administrator may be allowed to do any of the above on ‘the fly’ directly from any browser agnostic to any device or platform.

In some examples, notification of incoming communication requests to the team may be set to “Not Notify”, “Immediately Notify”, or based on a specified “Time Delay” notification for each team member. Ring type, audio sound, volume etc. may be set by the administrator based on importance of the call or based on machine learning. Based on the above points the administrator may create an unlimited number of notification profiles for the team. For example, the administrator may setup a ring sequence such that a team of the 3 sales agents may have: (1) all three agents are notified about a request at the same time; (2) each agent is notified in a pre-determined priority sequence; or (3) 2 agents are notified at the same time and the third agent is notified on a delayed notification or any other sequence of notification that is practical for that situation.

Each team account may provide ability to add up to a pre-defined number of members to the team. Additional seats may be added to the team at any time by a designated team administrator. “Hot seats” may allow team members to be added or removed from the team as required. For example, an existing team may have 4 members. For a particular time period, a high number of incoming communication requests may be expected. Thus, an administrator may remove a team member and replace with a dedicated person to handle the expected requests without having to purchase an additional license. In another embodiment a services company may utilize the Hot Seats as seats for handling US based English speaking communication requests at one time in the day and then reassign the same hot seats to a new set of representatives to handle French speaking communication requests that same evening. In another embodiment, an automated system may be used to reassign the Hot Seats on a predictable periodic basic. Hots seats may also be used and transferred geographically, on the fly. For example, a hot seat may be used by a salesperson dedicated to the California market during the day, while in the evening the same hot seat may be transferred to a salesperson for India.

Traditional conferencing applications tie a user to a seat and require that a new seat be purchased for each new user. A system according to embodiments may provide the ability to dynamically switch and change team members as needed based on the number of seats purchased (the administrator may always add additional seats at any time too). The service may also include an AI system that analyzes the team's communication history and automatically makes a recommendation for an optimal number of team seats that should be secured.

FIG. 4H shows example UI 492C listing teams 481, which a particular subscriber may be associated with. The “My Current Teams” portion 483 of the UI may provide a listing of the teams of which the subscriber is a member. The listing 485 may include URLs of the teams, a membership status of the subscriber (e.g., member, administrator), seats in the team, notification rule for the subscriber within each team, if and when each team expires, and a status of the team and/or the subscriber. Upon becoming a member in a new team, the listing may be updated automatically, or the subscriber may add the new team through the example UI 492C.

One-to-One communications between two subscribers may bring up previous messaging between those two subscribers. Those messages may have been communicated when the participants where in a communication session or may have been messages from the subject line from a missed or declined communication request. Members in a one-to-one communication session may invite another member to that communication session and a dynamic group may be created. In one embodiment, subsequent messages may be shared amongst that group and uniquely stored. The next time this particular group re-convenes, members of that group may view the previous sequence of messages to that group and not the one-to-one messages that were previously sent before it became a group communication session. In another embodiment, members may acknowledge that messages from the past session can be shared with an invited member that is added to the group. In yet another embodiment, messages in a particular session may be cleared and a new message session may be created inclusive of the invited member. In addition to exchanged messages, other conversation history, shared files, etc. may also be made available subject to the rules for dynamic groups as discussed herein.

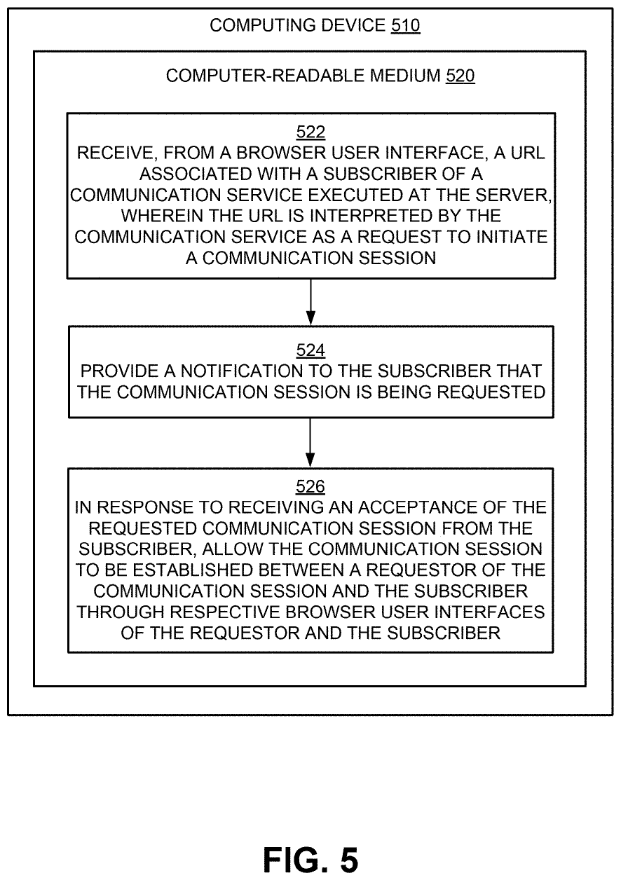

FIG. 5 is a flow diagram illustrating an example flow of high level actions for one-action URL based communication services, arranged in accordance with at least some embodiments described herein.

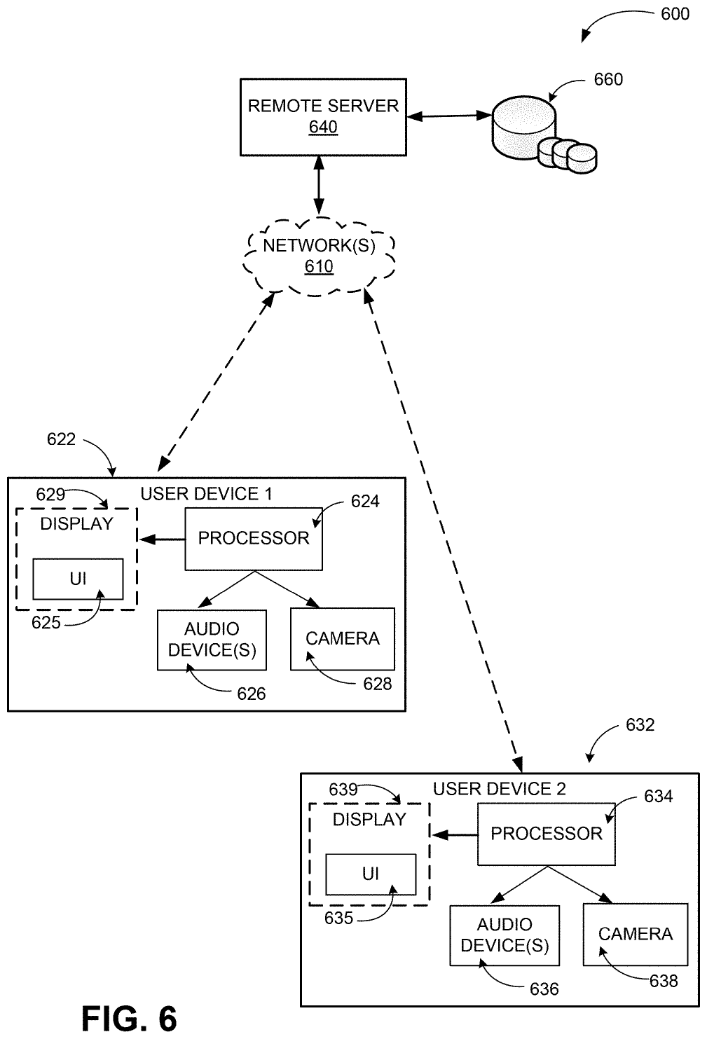

Example methods may include one or more operations, functions, or actions as illustrated by one or more of blocks 522, 524 and 526 may in some embodiments be performed by a computing device such as the computing device 600 in FIG. 6. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 522-526 may be implemented through execution of computer-executable instructions stored in a computer-readable medium such as a computer-readable medium 520 of a computing device 510. Some of the operations may also be performed between human callers, via automated machine to machine system, or automated machine to human system.

An example process to provide one-action URL based communication services and management of communications on such services may begin with block 522, “RECEIVE, FROM A BROWSER USER INTERFACE, A URL ASSOCIATED WITH A SUBSCRIBER OF A COMMUNICATION SERVICE EXECUTED AT THE SERVER, WHERE THE URL IS INTERPRETED BY THE COMMUNICATION SERVICE AS A REQUEST TO INITIATE A COMMUNICATION SESSION”, where a subscriber of a communication service may receive a communication session request from another subscriber or an anonymous caller using a URL assigned to the subscriber. The request may be initiated through any browser by the requestor entering the subscriber's URL (e.g., “url.live/johndoe/call”) into the address bar, the requestor activating a chat widget on any website, or a subscriber activating their “call someone” button on their service dashboard.

Block 522 may be followed by block 524, “PROVIDE A NOTIFICATION TO THE SUBSCRIBER THAT THE COMMUNICATION SESSION IS BEING REQUESTED”, where the subscriber may be provided with a notification that the communication session is being requested. The requestor may be provided with options to select a communication mode (e.g., audio, video, text messaging), as well as, an option to provide context information, in some examples. Upon receiving the request, the communication service may present the requestor with a web page, for example, a personalized web page (profile) associated with the subscriber. The subscriber may receive the request (and the optional context) through a browser on a web page where they are logged in to their account with the communication service.

Block 524 may be followed by block 526, “IN RESPONSE TO RECEIVING AN ACCEPTANCE OF THE REQUESTED COMMUNICATION SESSION FROM THE SUBSCRIBER, ALLOW THE COMMUNICATION SESSION TO BE ESTABLISHED BETWEEN A REQUESTOR OF THE COMMUNICATION SESSION AND THE SUBSCRIBER THROUGH RESPECTIVE BROWSER USER INTERFACES OF THE REQUESTOR AND THE SUBSCRIBER”, where the communication session may be established between the requestor and the subscriber through respective browser user interfaces of the requestor and the subscriber upon receiving an acceptance of the requested communication session from the subscriber. The subscriber may accept, reject, or modify the requested communication mode. If the subscriber is not logged in or is unavailable, the requestor may be allowed to leave a voicemail, video message, or text message for the subscriber.

The operations included in the process of FIG. 5 are for illustration purposes. One-action URL based services and management of such services may be implemented by similar processes with fewer or additional operations, as well as in different order of operations using the principles described herein. The operations described herein may be executed by one or more processors operated on one or more computing devices, one or more processor cores, and/or specialized processing devices, among other examples.

FIG. 6 illustrates major components of an example system for providing one-action URL based services and management of such services, arranged in accordance with at least some embodiments described herein.

The example system shown in diagram 600 may include a remote server 640 managing operations of a communication service according to embodiments, one or more data stores 660 storing subscriber data, communication telemetry data, and similar information. The remote server 640 may communicate with user devices such as user device 1 (622) and user device 2 (632) over one or more networks, which may include private, public, wired, wireless, and other forms of networks using any suitable protocols (e.g., terrestrial and/or satellite-based communications or a combination thereof).

User device 1 (622) may include a display 629, which may be integrated to the user device or an external display device. Various UIs 626 associated with initiating a communication session, receiving a communication session request, managing communication options, profile and communication service configurations, etc. may be displayed through the display 629. User device 1 (622) may also include audio devices 626 such as a microphone, a speaker, or similar ones, and a camera 628 or similar image capture devices. A processor 624 may control the audio and visual input/output devices, communicate with the remote server 640, and execute a browser to allow communication sessions to be facilitated as described herein.

Similarly, user device 2 (632) may include a display 639, which may be integrated to the user device or an external display device. Various UIs 636 associated with initiating a communication session, receiving a communication session request, managing communication options, profile and communication service configurations, etc. may be displayed through the display 639. User device 2 (632) may also include audio devices 636 such as a microphone, a speaker, or similar ones, and a camera 638 or similar image capture devices. A processor 634 may control the audio and visual input/output devices, communicate with the remote server 640, and execute a browser to allow communication sessions to be facilitated as described herein.

User devices 1 and 2 (622, 632) may be any form of computing device including, but not limited to, desktop, laptop, mobile, wearable, and other forms. User devices 1 and 2 (622, 632) may enable establishment and facilitation of peer-to-peer communication sessions between callers using a URL dedicated to a called subscriber of the communication service as described herein. The communication may be device-, operating service-, platform-, location-, and application-agnostic. That is, communication sessions may be initiated and facilitated through browsers and a peer-to-peer protocol such as WebRTC. In other embodiments, other services such as messaging, payments, and comparable ones may also be provided through the system shown in diagram 600.

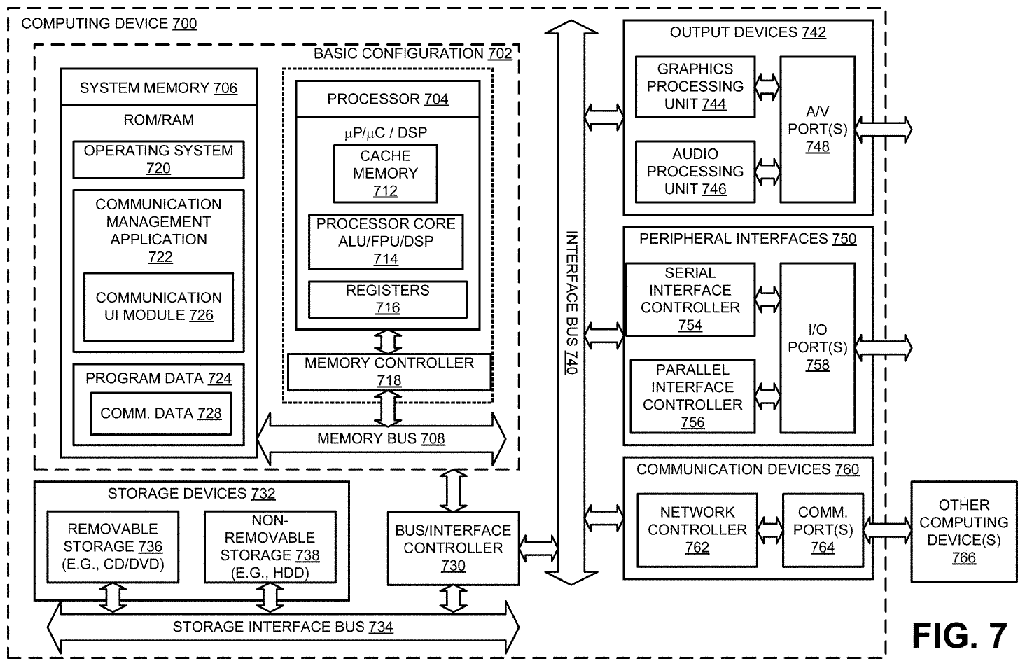

FIG. 7 illustrates a computing device, which may be used to manage one-action URL based services and management of such services, arranged in accordance with at least some embodiments described herein.

In an example basic configuration 702, the computing device 700 may include one or more processors 704 and a system memory 706. A memory bus 708 may be used to communicate between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one or more levels of caching, such as a cache memory 712, a processor core 714, and registers 716. The example processor core 714 may include an arithmetic logic unit (ALU), a floating point unit (FPU), a digital signal processing core (DSP core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RANI), non-volatile memory (such as ROM, flash memory, etc.) or any combination thereof. The system memory 706 may include an operating system 720, a communication management application 722, and program data 724. The communication management application 722 may include a communication UI module 726. The communication management application 722 may be configured to receive a call request from a subscriber of the communication service or non-subscriber. If a browser is not opened at the computing device 700 or the user is not logged in to their communication service account, the communication management application 722 may, in conjunction with communication UI module 726, activate a browser and log the user in, such that the user can receive the incoming call and accept or reject through the opened browser. The program data 724 may include communication data 728 such call telemetry, context, among other data, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (e.g., one or more output devices 742, one or more peripheral interfaces 750, and one or more communication devices 760) to the basic configuration 702 via the bus/interface controller 730. Some of the example output devices 742 include a graphics processing unit 744 and an audio processing unit 746, which may be configured to communicate to various external devices such as a display or speakers via one or more A/V ports 748. One or more example peripheral interfaces 750 may include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 760 includes a network controller 762, which may be arranged to facilitate communications with one or more other computing devices 766 over a network communication link via one or more communication ports 764. The one or more other computing devices 766 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 700 may be implemented as a part of a specialized server, mainframe, or similar computer that includes any of the above functions. The computing device 700 may also be implemented as a personal computer including both laptop computer and non-laptop computer configurations.

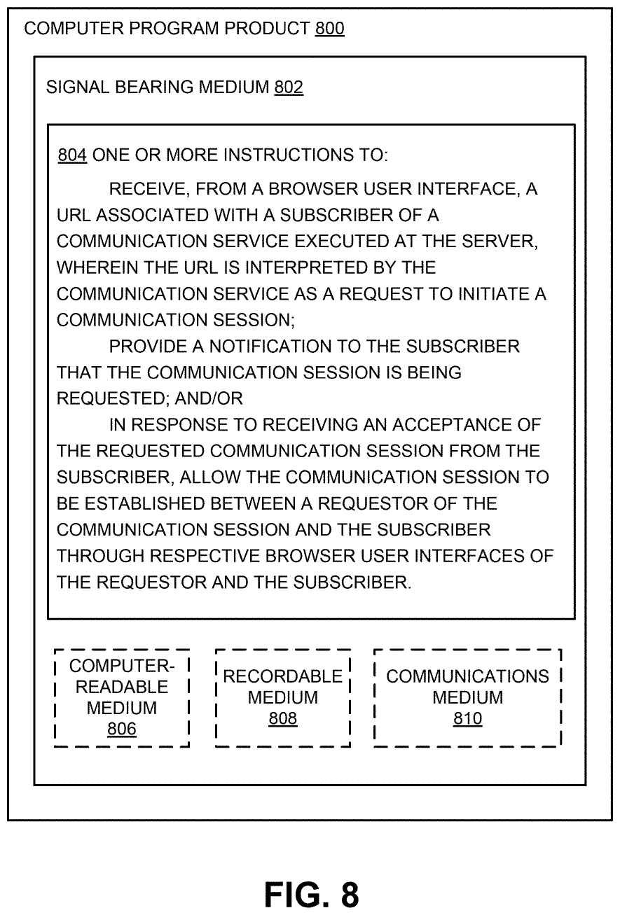

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 704 in FIG. 7, the communication management application 722 may perform or control performance of one or more of the tasks shown in FIG. 8 in response to the instructions 804 conveyed to the processor 704 by the signal bearing medium 802 to perform actions associated with the control and optimization of agent delivery as described herein. Some of those instructions may include, for example, receive, from a browser user interface, a URL associated with a subscriber of a communication service executed at the server, where the URL is interpreted by the communication service as a request to initiate a communication session; provide a notification to the subscriber that the communication session is being requested; and/or in response to receiving an acceptance of the requested communication session from the subscriber, allow the communication session to be established between a requestor of the communication session and the subscriber through respective browser user interfaces of the requestor and the subscriber, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 704 by an RF signal bearing medium, where the signal bearing medium 802 is conveyed by the communications medium 810 (e.g., a wireless communications medium conforming with the IEEE 802.11 standard).

According to some examples, a method to provide one-action uniform resource locator (URL) based services through browser user interfaces is described. The method may include receiving, from a browser user interface, a URL associated with a subscriber of a service, wherein the URL includes a first identifier for the service, a second identifier for the subscriber, and one or more terms associated with an action; determining the subscriber based on the first identifier in the URL; determining the action and one or more parameters associated with the action based on the one or more terms in the URL; and performing the determined action for the determined subscriber according to the one or more parameters.

According to other examples, the one or more terms associated with the action are descriptive terms. A number and a type of the one or more parameters is based on the action. The action is transmission of a communication and the one or more parameters define one or more of a type of communication, a context for the communication, or a content for the communication. The action is submission of a payment to a person or an entity and the one or more parameters define the person or the entity to be paid, an amount of the payment, or a timing of the payment.

According to further examples, a method to provide one-action uniform resource locator (URL) based communication through browser user interfaces is described. The method may include receiving, from a browser user interface, a URL associated with a subscriber of a communication service, wherein the URL is interpreted by the communication service as a request to initiate a communication session; providing a notification to the subscriber that the communication session is being requested; and in response to receiving an acceptance of the requested communication session from the subscriber, allowing the communication session to be established between a requestor of the communication session and the subscriber through respective browser user interfaces of the requestor and the subscriber.

According to yet other examples, the requestor of the communication session is a non-subscriber of the communication service or another subscriber of the communication service. The method may further include if the requestor of the communication session is a non-subscriber of the communication service, allowing the requestor to initiate the communication session anonymously without having create an account or to register as a user with the communication service prior to requesting the communication session. The method may also include if the requestor of the communication session is a non-subscriber of the communication service, allowing the requestor to identify himself or herself through a context input. The method may further include allowing the requestor of the communication session to provide a context for the requested communication session through a context input; allowing the requestor of the communication session to select a suggested communication mode for the requested communication session; or allowing the subscriber to accept or to modify the suggested communication mode for the requested communication session. The communication mode is a voice call, a video conference, a text message exchange, a desktop sharing session, an application sharing session, or a data sharing session.

According to yet further examples, the method may also include if the requested communication session is rejected by the subscriber, allowing the requestor to leave a voice message, a text message, or a video message for the subscriber. The method may further include allowing the subscriber to initiate another communication session through a user interface control on a webpage associated with the subscriber hosted by the communication service; a navigation button on the webpage associated with the subscriber hosted by the communication service; or directly from a contacts user interface of the webpage associated with the subscriber hosted by the communication service. The method may also include allowing the navigation button to be moved to a desktop of a computing device, wherein the navigation button maintains functionality associated with initiating another communication session; allowing the subscriber or a non-subscriber to initiate another communication session through a chat widget on a webpage not hosted by the communication service. The method may further include allowing the subscriber to integrate the chat widget to the webpage not hosted by the communication service by copying code associated with the chat widget from the webpage associated with the subscriber hosted by the communication service.

According to some examples, the method may further include allowing the subscriber to select among one or more options for a type of requestor allowed to request the communication session through a user interface of the webpage associated with the subscriber hosted by the communication service; providing the requestor with access to one or more subscriber profiles to initiate the communication session; allowing the subscriber to select among one or more options for when the requestor is allowed to request the communication session through a user interface of the webpage associated with the subscriber hosted by the communication service; or presenting a schedule to the subscriber through the user interface of the webpage associated with the subscriber hosted by the communication service for the subscriber to select times when the requestor is allowed to request the communication session. The times when the requestor is allowed to request the communication session are determined by overlapping a schedule of the requestor with the schedule of the subscriber. The communication session is facilitated in a peer-to-peer mode between computing devices of the requestor and the subscriber or in a server-managed mode.

According to other examples, the method may further include allowing the subscriber to maintain multiple active communication sessions concurrently; allowing the subscriber to maintain multiple communication modes for each individual communications session during the communication sessions concurrently; allowing the subscriber to select and to customize and make available selectively to the requestor one or more profiles on a webpage associated with the subscriber hosted by the communication service; allowing the subscriber to associate the one or more profiles with one or more of a type of requestor, a time of request, or a subscriber computing device; allowing the subscriber to select an option to receive a notification about the request to initiate the communication session, wherein the option includes one or more of receiving the notification through a dashboard user interface of a webpage associated with the subscriber hosted by the communication service, receiving the notification as a text message, or receiving the notification through a mobile application executed on a mobile computing device associated with the subscriber; or allowing the subscriber to add additional subscribers to the established communication session.

According to further examples, the established communication session is maintained active until a last subscriber or non-subscriber participant leaves the communication session. Each established communication session by the communication service is unique and is not reestablished once the last participant leaves a communication session. The method may further include allowing the subscriber to leave the established communication session and rejoin through one or more of another browser, another location, another communication mode, or another computing device. The method may also include collecting metric data associated with the established communication session from one or more computing devices or back-end servers associated with the communication session; and storing the collected metric data on the one or more computing devices or the back-end servers. Initiation and facilitation of the communication session is independent of one or more of a browser, a computing device, a platform, a location, a language, or a communication mode. The method may further include allowing the subscriber to form a team by associating a group of subscribers; and managing incoming communication session requests for the team based on one or more rules defined by a member of the team. The method may also include allowing a member of the team to define roles for other members of the team and define a sequence of incoming communications and mode of incoming communication session request forwarding among the team members, allowing a member of the team to select profile webpages for individual team members and for the team, or in response to another subscriber or non-subscriber participant joining the communication session subsequently, making communication history and exchanged communication records available to participants of the communication session based on a timing of their participation.

According to yet other examples, a method to provide one-action uniform resource locator (URL) based communication through a mobile application is described. The method may include receiving a request to initiate a communication session at the mobile application executed on a mobile computing device associated with a subscriber of a communication service, wherein the request to initiate the communication session is submitted in form of a URL associated with the subscriber through a browser; activating a mobile browser executed on the mobile computing device; activating a webpage associated with the subscriber hosted by the communication service through the activate mobile browser; and in response to receiving an acceptance of the requested communication session from the subscriber, allowing the communication session to be established between a requestor of the communication session and the subscriber through user interfaces of the browser and the mobile browser. The browser may also be a mobile browser. The mobile application may be in an active mode capable of receiving incoming requests to initiate a communication session without being displayed on a desktop of the mobile computing device. The method may also include allowing the subscriber to inactivate and to reactivate the mobile application.

According to yet further examples, a method to provide a dual-purpose navigation control for one-action uniform resource locator (URL) based communication described. The method may include displaying the dual-purpose navigation control on a browser user interface of a webpage associated with a subscriber hosted by a communication service, wherein the communication service provides multiple webpages for managing distinct aspects of communications for the subscriber; navigating to one or more of the multiple webpages based on subscriber interaction with the dual-purpose navigation control, wherein the communication service is arranged to provide requests to initiate a communication session received from subscribers or non-subscribers through a browser in form of a URL associated with the subscriber through one of the multiple webpages; and displaying a badge that includes an option to initiate a communication session with another subscriber of the communication service in response to another subscriber interaction with the dual-purpose navigation control.

According to some examples, displaying the badge may include displaying one or more control elements corresponding to distinct communication modes to be used in the communication session, displaying a number of outstanding communication session requests through the badge, or displaying information associated with the outstanding communication session requests through the badge. The method may also include allowing the subscriber to move the dual-purpose navigation button onto a desktop of a computing device; and providing communication session initiation functionality through the dual-purpose navigation button on the desktop. The method may further include upon receiving an activation of the dual-purpose navigation button on the desktop, displaying one or more control elements corresponding to distinct communication modes to be used in the communication session; and upon receiving a selection of the displayed one or more control elements, activating a browser to initiate the communication session in a communication mode corresponding to the selected control element.

According to other examples, a method to provide a chat widget for one-action uniform resource locator (URL) based communication is described. The method may include displaying code for the chat widget on a browser user interface of a webpage associated with a subscriber hosted by a communication service, wherein the communication service is arranged to provide requests to initiate a communication session received from subscribers or non-subscribers through a browser in form of a URL associated with the subscriber through one of the multiple webpages; allowing the subscriber to integrate the chat widget to a webpage not hosted by the communication service through copying and pasting of the code; and upon receiving an activation of the chat widget on the webpage not hosted by the communication service, allowing a requestor to request initiation of a communication session with the subscriber through the browser. Allowing the requestor to request the initiation of the communication session with the subscriber through the browser may include submitting the URL associated with the subscriber through a browser page.

According to further examples, a server to provide one-action uniform resource locator (URL) based communication through browser user interfaces is described. The server may include a communication device; a memory configured to store instructions; and a processor coupled to the communication device and the memory. The processor, in conjunction with the instructions stored in the memory, may be configured to receive, from a browser user interface, a URL associated with a subscriber of a communication service executed at the server, wherein the URL is interpreted by the communication service as a request to initiate a communication session; provide a notification to the subscriber that the communication session is being requested; and in response to receiving an acceptance of the requested communication session from the subscriber, allow the communication session to be established between a requestor of the communication session and the subscriber through respective browser user interfaces of the requestor and the subscriber.

According to yet other examples, the requestor of the communication session is a non-subscriber of the communication service or another subscriber of the communication service. The processor may be further configured to if the requestor of the communication session is a non-subscriber of the communication service, allow the requestor to initiate the communication session anonymously; or if the requestor of the communication session is a non-subscriber of the communication service, allow the requestor to identify himself or herself through a context input. The processor may also be configured to allow the requestor of the communication session to provide a context for the requested communication session through a context input, allow the requestor of the communication session to select a suggested communication mode for the requested communication session, or allow the subscriber to accept or to modify the suggested communication mode for the requested communication session. The communication mode is a voice call, a video conference, a text message exchange, a desktop sharing session, an application sharing session, or a data sharing session. The processor may be further configured to if the requested communication session is rejected by the subscriber, allow the requestor to leave a voice message, a text message, or a video message for the subscriber.

According to yet further examples, the processor may be further configured to allow the subscriber to initiate another communication session through one of: a user interface control on a webpage associated with the subscriber hosted by the communication service; a navigation button on the webpage associated with the subscriber hosted by the communication service; or directly from a contacts user interface of the webpage associated with the subscriber hosted by the communication service. The processor may also be configured to allow the navigation button to be moved to a desktop of a computing device, wherein the navigation button maintains functionality associated with initiating another communication session, allow the subscriber or a non-subscriber to initiate another communication session through a chat widget on a webpage not hosted by the communication service, allow the subscriber to integrate the chat widget to the webpage not hosted by the communication service by copying code associated with the chat widget from the webpage associated with the subscriber hosted by the communication service.

According to some examples, the processor may be further configured to allow the subscriber to select among one or more options for a type of requestor allowed to request the communication session through a user interface of the webpage associated with the subscriber hosted by the communication service, allow the subscriber to select among one or more options for when the requestor is allowed to request the communication session through a user interface of the webpage associated with the subscriber hosted by the communication service, present a schedule to the subscriber through the user interface of the webpage associated with the subscriber hosted by the communication service for the subscriber to select times when the requestor is allowed to request the communication session. The communication session is facilitated in a peer-to-peer mode between computing devices of the requestor and the subscriber or in a server-managed mode. The processor may be further configured to allow the subscriber to maintain multiple active communication sessions concurrently, allow the subscriber to maintain multiple communication modes during the communication sessions concurrently, allow the subscriber to select and to customize one or more profiles on a webpage associated with the subscriber hosted by the communication service, or allow the subscriber to associate the one or more profiles with one or more of a type of requestor, a time of request, or a subscriber computing device.

According to other examples, the processor may be further configured to allow the subscriber to select an option to receive a notification about the request to initiate the communication session, wherein the option includes one or more of receiving the notification through a dashboard user interface of a webpage associated with the subscriber hosted by the communication service, receiving the notification as a text message, or receiving the notification through a mobile application executed on a mobile computing device associated with the subscriber. The processor may also allow the subscriber to add additional subscribers to the established communication session. The established communication session is maintained active until a last participant leaves the communication session. Each established communication session by the communication service is unique and is not reestablished once the last participant leaves a communication session. The processor may be further configured to allow the subscriber to leave the established communication session and rejoin through one or more of another browser, another location, another communication mode, or another computing device; collect metric data associated with the established communication session from computing devices associated with the communication session; and store the collected metric data.

According to further examples, initiation and facilitation of the communication session is independent of one or more of a browser, a computing device, a platform, a location, a language, or a communication mode. The processor may be further configured to allow the subscriber to form a team by associating a group of subscribers; and manage incoming communication session requests for the team based on one or more rules defined by a member of the team. The processor may also be configured to allow a member of the team to define roles for other members of the team and define a sequence of incoming communication session request forwarding among the team members, allow a member of the team to select profile webpages for individual team members and for the team, in response to another subscriber or non-subscriber participant joining the communication session subsequently, make communication history and exchanged communication records available to participants of the communication session based on a timing of their participation.

According to yet other examples, a computer-readable, non-transitory medium with instructions stored thereon to provide one-action uniform resource locator (URL) based communication through browser user interfaces is described. The instructions, when executed, may be arranged to cause a computing device to perform actions described herein.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, t some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1.-84. (canceled)

85. A method to provide one-action uniform resource locator (URL) based services, the method comprising:
receiving a URL associated with a subscriber of a service, wherein the URL includes a first identifier for the service, a second identifier for the subscriber, and one or more descriptive terms associated with an action;
identifying the subscriber based on the second identifier in the URL;
determining the action and one or more parameters associated with the action based on the one or more descriptive terms in the URL, wherein the one or more descriptive terms describe the action and/or the one or more parameters; and
performing the determined action for the identified subscriber according to the one or more parameters.

86. The method of claim 85, wherein a number and a type of the one or more parameters is based on the action.

87. The method of claim 85, wherein the action is:
submission of a payment to a person or an entity and the one or more parameters define a person or an entity to be paid, an amount of the payment, or a timing of the payment;
shipment of an item and the one or more parameters define the person or the entity to receive the item, the item, a timing of the shipment, or a type of the shipment; or
delivery of a file and the one or more parameters define the person or the entity to receive the file, the file, a timing of the delivery, or a type of the delivery.

88. A method to provide one-action uniform resource locator (URL) based communication services, the method comprising:
receiving a URL associated with a subscriber of a communication service, wherein the URL includes a first identifier for the communication service, a second identifier for the subscriber, and one or more descriptive terms associated with a request for a communication session with the subscriber;
identifying the subscriber based on the second identifier in the URL;
determining one or more parameters associated with the requested communication session based on the one or more descriptive terms in the URL, wherein the one or more descriptive terms describe at least one or more of a type and a timing of the requested communication session; and
establishing or scheduling the requested communication session between the identified subscriber and a requestor submitting the URL according to the determined one or more parameters.

89. The method of claim 88, wherein the one or more parameters define one or more of a type of the communication session, a context for the communication session, or a content for the communication session.

90. The method of claim 88, further comprising:
if the requestor is a non-subscriber of the communication service, allowing the requestor to
initiate the communication session anonymously without having to create an account or to register as a subscriber with the communication service prior to requesting the communication session; or
identify himself or herself through a context input.

91. The method of claim 88, further comprising:
allowing the subscriber to accept, reject, or modify a suggested communication mode for the requested communication session or an employed communication mode during the established communication session, wherein the communication mode is a voice call, a video conference, a text message exchange, a desktop sharing session, an application sharing session, or a data sharing session; and
if the requested communication session is rejected by the subscriber, allowing the requestor to leave a voice message, a text message, or a video message for the subscriber.

92. The method of claim 88, further comprising:
allowing the subscriber to select times when the requestor is allowed to request a communication session with the subscriber;
upon receiving the URL associated with the subscriber, presenting the subscriber selected times to the requestor; and
upon receiving a selection of one of the presented times from the requestor, scheduling the requested communication session at the time selected by the requestor.

93. The method of claim 92, further comprising:
transmitting a message to the requestor confirming the scheduled communication session, wherein the message includes a link to join the communication session.

94. The method of claim 88, further comprising:
providing the subscriber with an option to maintain multiple active communication sessions concurrently with one or more communication modes for each individual communication session.

95. The method of claim 88, further comprising:
allowing the subscriber or a non-subscriber to initiate another communication session through a chat widget on a webpage; and
allowing the subscriber to integrate the chat widget to the webpage by copying code associated with the chat widget from a webpage associated with the subscriber and hosted by the communication service.

96. The method of claim 88, further comprising:
in response to detecting a mobile application associated with the subscriber being in an active mode capable of receiving incoming communication session requests, allowing the communication session to be established through the mobile application.

97. The method of claim 88, further comprising one or more of:
allowing the subscriber to make available, to requestors, one or more customizable profiles on a webpage associated with the subscriber; or
collecting metric data associated with the established communication session from one or more computing devices or back-end servers associated with the communication session, wherein a type of the metric data is selected based on one of the one or more customizable profiles.

98. The method of claim 97, further comprising:
selecting one of the one or more customizable profiles to be presented to the requestor based on the one or more descriptive terms in the URL associated with one or more of a type of the communication session, a context for the communication session, or a content for the communication session; or
providing the subscriber with an option to associate the one or more profiles with one or more of a type of requestor, a time of request, or a subscriber computing device.

99. The method of claim 97, wherein the type of metric data comprises one or more of a type of communication session, a context for the communication session, a timing of the communication session, a duration of the communication session, or other subscribers participating in the communication session.

100. A method to provide one-action uniform resource locator (URL) based communication services, the method comprising:
receiving a URL associated with a subscriber of a communication service, wherein the URL includes a first identifier for the communication service, a second identifier for the subscriber, and one or more descriptive terms associated with a request for a communication session with the subscriber;
identifying the subscriber based on the second identifier in the URL;
determining one or more parameters associated with the requested communication session based on the one or more descriptive terms in the URL, wherein the one or more descriptive terms describe at least one or more of a type and a timing of the requested communication session;
establishing the requested communication session between the identified subscriber and a requestor submitting the URL according to the determined one or more parameters; and
allowing the subscriber or the requestor to invite another participant to join the established communication session, wherein the other participant is allowed to invite a further participant to join the established communication session and the established communication session is maintained until a last participant leaves the established communication session.

101. The method of claim 100, further comprising:
allowing the subscriber to join and rejoin, upon leaving temporarily, the established communication session in a device-, location-, or, platform-agnostic manner.

102. The method of claim 100, further comprising:
allowing the subscriber to form a team by associating a group of subscribers; and
one or more of:
managing incoming communication session requests for the team based on one or more rules defined by a member of the team; and
allowing a member of the team to define roles for other members of the team and to define a sequence of incoming communication session request forwarding among the team members.

103. The method of claim 102, wherein the one or more rules are associated with a notification time delay for each team member, a communication mode for each team member, or an expiration date of membership in the team for each team member.

104. The method of claim 100, further comprising:
providing the subscriber with an option to receive a notification about the request for the communication session, wherein the option includes one or more of receiving the notification through a dashboard user interface of a webpage associated with the subscriber and hosted by the communication service, receiving the notification as a message, or receiving the notification through a mobile application executed on a mobile computing device associated with the subscriber.
